(19) United States
(12) Patent Application Publication
(10) Pub. No.: US 2014/0366640 A1
(43) Pub. Date: Dec. 18, 2014

(54) Fluid Flow Measurement Sensor, Method, and Analysis

(71) Applicants: Feroze J. Sidhwa, Carrollton, TX (US); Robert E. Maute, Richardson, TX (US)

(72) Inventors: Feroze J. Sidhwa, Carrollton, TX (US); Robert E. Maute, Richardson, TX (US)

(73) Assignee: REM SCIENTIFIC ENTERPRISES, INC., Richardson, TX (US)

(21) Appl. No.: 14/122,465

(22) PCT Filed: May 25, 2012
(86) PCT No.: PCT/US12/39651

§ 371 Date: Aug. 26, 2014

Related U.S. Application Data
(60) Provisional application No. 61/491,036, filed on May 27, 2011.

(51) Int. Cl. G01F 1/58; E21B 47/10

(52) U.S. Cl. CPC G01F 1/588; E21B 47/102; G01F 1/584
USPC 73/861.12

(57) ABSTRACT

Fluid flow measurement sensor, method, and analysis are disclosed, which provide for the measurement and processing of array sensor data. Other embodiments provide for determination of flow rate from the array sensor data, and for diagnosis of a conduit wall anomaly based on anomaly shape.

This application claims the benefit of U.S. Provisional Application Ser. No. 61/491,036, entitled “Fluid Flow Measurement Sensor, Method, and Analysis,” filed on May 27, 2011, which application is hereby incorporated herein by reference.

### CROSS-REFERENCE TO RELATED APPLICATIONS

This application is related to the following co-pending and commonly-assigned patent applications: application Ser. No. 12/987,773, filed Jan. 10, 2011, entitled “Apparatus and Method for Fluid Flow Measurement with Sensor Shielding;” application Ser. No. 12/947,402, filed Nov. 16, 2010, entitled “Fluid Flow Measuring Device and Method;” and application Ser. No. 12/513,807 (now U.S. Pat. No. 8,156,799), filed May 6, 2009, entitled “Rotating Fluid Flow Measurement Device and Method,” all of which are hereby incorporated herein by reference.

### TECHNICAL FIELD

The present invention relates generally to measurement of fluid flow, and more particularly to a fluid flow measurement sensor, method, and analysis.

### BACKGROUND

An oil and gas well is shown in FIG. 1 generally at 60. Well construction involves drilling a hole or borehole 62 in the surface 64 of land or ocean floor. The borehole 62 may be several thousand feet deep, and drilling is continued until the desired depth is reached. Fluids such as oil, gas and water reside in porous rock formations 68. A casing 72 is normally lowered into the borehole 62. The region between the casing 72 and rock formation 68 is filled with cement 70 to provide a hydraulic seal. Usually, tubing 74 is inserted into the hole 62, the tubing 74 including a packer 76 which comprises a seal. A packer fluid 78 is disposed between the casing 72 and tubing 74 annular region. Perforations 80 may be located in the casing 72 and cement 70, into the rock 68, as shown.

Production logging involves obtaining logging information about an active oil, gas or water-injection well while the well is flowing. A logging tool instrument package comprising sensors is lowered into a well, the well is flowed and measurements are taken. Production logging is generally considered the best method of determining actual downhole flow. A well log, a collection of data from measurements made in a well, is generated and is usually presented in a long strip chart paper format that may be in a format specified by the American Petroleum Institute (API), for example.

The general objective of production logging is to provide information for the diagnosis of a well. A wide variety of information is obtainable by production logging, including determining water entry location, flow profile, off depth perforations, gas influx locations, oil influx locations, non-performing perforations, thief zone stealing production, casing leaks, crossflow, flow behind casing, verification of new well flow integrity, and floodwater breakthrough, as examples. The benefits of production logging include increased hydrocarbon production, decreased water production, detection of mechanical problems and well damage, identification of unproductive intervals for remedial action, testing reservoir models, evaluation of drilling or completion effectiveness, monitoring Enhanced Oil Recovery (EOR) process, and increased profits, for example. An expert generally performs interpretation of the logging results.

In current practice, measurements are typically made in the central portion of the wellbore cross-section, such as of spinner rotation rate, fluid density and dielectric constant of the fluid mixture. These data may be interpreted in an attempt to determine the flow rate at any point along the borehole. Influx or exit rate over any interval is then determined by subtracting the flow rates at the two ends of the interval.

In most producing oil and gas wells, the wellbore itself generally contains a large volume percentage or fraction of water, but often little of this water flows to the surface. The water that does flow to the surface enters the wellbore, which usually already contains a large amount of water. The presence of water already in the wellbore, however, makes detection of the additional water entering the wellbore difficult and often beyond the ability of conventional production logging tools.

Furthermore, in deviated and horizontal wells with multiphase flow, and also in some vertical wells, conventional production logging methods are frequently misleading due to complex and varying flow regimes or patterns that cause misleading and non-representative readings. Generally, prior art production logging is performed in these complex flow regimes in the central area of the borehole and yields frequently misleading results, or may possess other severe limitations. Often the location of an influx of water, which is usually the information desired from such logging, is not discernable due to the small change in current measurement responses superimposed upon large variations caused by the multiphase flow conditions.

As described in commonly owned application Ser. No. 12/987,773, filed Jan. 10, 2011, entitled “Apparatus and Method for Fluid Flow Measurement with Sensor Shielding;” application Ser. No. 12/947,402, filed Nov. 16, 2010, entitled “Fluid Flow Measuring Device and Method;” and application Ser. No. 12/513,807, filed May 6, 2009, entitled “Rotating Fluid Flow Measurement Device and Method,” all of which are hereby incorporated herein by reference, one fluid flow measurement approach involves using an electromagnetic sensing device disposed adjacent the borehole wall to measure radial flow of conductive fluid entering or leaving the borehole. Embodiments disclosed herein provide improvements and additional features and implementations for such devices and methods.

### SUMMARY OF THE INVENTION

Technical advantages are generally achieved by preferred embodiments of the present invention which provide measurement and processing of array sensor data. Other embodiments provide for determination of flow rate from the array sensor data, and for diagnosis of a conduit wall anomaly based on anomaly shape.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a cross-sectional view of an oil or gas well;

FIG. 2 illustrates an embodiment of a logging tool string;

FIG. 3 is a block diagram of electronics for processing array sensor data;

FIGS. 4A-4C are circuit diagrams of the microcontroller board of FIG. 3;

FIGS. 5A-5H are circuit diagrams of the multi-channel analog signal conditioner boards of FIG. 3;

FIGS. 6A-6C are flowcharts showing the operation the electronics of FIG. 3;

FIG. 7 is a block diagram showing the interconnection of the microcontroller and analog signal conditioner boards;

FIGS. 8A-8C illustrate an embodiment sensor housing;

FIGS. 8D-8E illustrate embodiment electrode configurations;

FIG. 9 illustrates overlap of adjacent sensor swaths in a conduit;

FIGS. 10A-10B are flow point maps;

FIG. 11 is a flowchart of flow rate determination;

FIG. 12 illustrates an example log format with multiple tracks showing various potential flows; and

FIG. 13 is a block diagram of a computing device in accordance with an embodiment of the present invention.

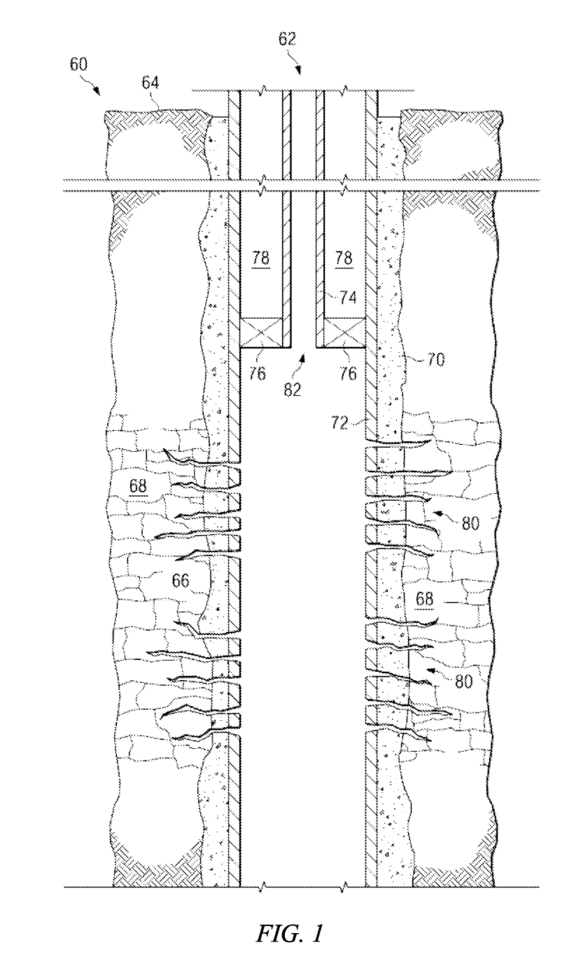

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely fluid flow measurement in a wellbore and analysis of the measurement data. The invention may also be applied, however, to other applications where the detection of conductive fluid flow is useful, such as pipes, casings, drill shafts, tanks, and swimming pools. The measurement tool may be used in vertical, deviated, and horizontal wells, and may be used in tubing, casing, slotted screens, slotted liners, and almost any well completion. Any type of conduit, wellbore, cylinder, pipe, shaft, tube, etc. is referred to herein generally as a casing.

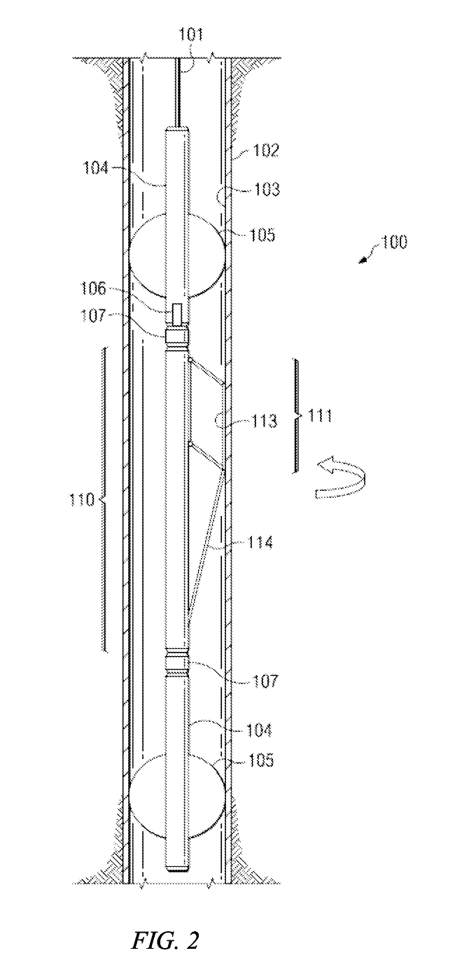

Referring to FIG. 2, a downhole measuring device for a wellbore is shown as sonde or tool string 100, which is configured to traverse a casing 102 with sensor pad 113. The general features of a measurement tool and the basic operation of an electromagnetic fluid flow sensor are disclosed in U.S. patent application Ser. Nos. 12/987,773, 12/947,402, and 12/513,807, incorporated by reference above, which may be referenced for an understanding of these general concepts. With respect to the embodiment of FIG. 2, tool 100 typically is lowered into and raised out of casing 102 on a wireline 101. The tool 100 azimuthally sweeps or rotates the sensor pad 113 on arm assembly 111 about the inner circumference 103 of the casing 102 as the tool 100 axially traverses the casing 102. Preferably, sensor pad 113 is maintained in contact or in close proximity to the wellbore wall 103.

Tool 100 includes stationary tool segments 104 and rotatable tool segment 110. A majority of the components of the tool bodies are preferably non-magnetic and preferably corrosion resistant materials, such as stainless steel, titanium, and the like. Stationary tool body 104 is preferably non-rotating, and is connected to rotating tool segment 110 by rotating joint 107, which allows for electrical communications (signals and power) to pass between the rotating tool segment 110 and at least one of the stationary tool segments 104. Rotating joint 107 may constitute slip rings or a wireless (e.g., radio frequency) transceiver pair for communication, as examples. Stationary tool body 104 may include one segment or preferably two segments with one being below the rotating tool body 110 and the other being above it and attached to wireline cable 101. Slip rings may be added at the bottom rotating joint 107 if other measurement tools are desired to be located below rotating tool segment 110.

Attached to stationary tool body 104 is at least one, but preferably two, three, four or more centralizers 105. Centralizers 105 generally maintain a long axis of the tool body 100 substantially parallel to the axis of casing 102, as well as substantially in the center of casing 102, thus generally maintaining sensor pad 113 in proximity to the wellbore wall 103 and substantially parallel to the axis of casing 102. Additionally, the centralizers generally keep rotation of stationary tool body 104 to a minimum while rotating tool body 110 rotates. Centralizers 105 may be made of metal ribbons or wires for example.

Rotating tool body 110 (along with arm assembly 111 and sensor pad 113) may be rotated by motor 106 located within stationary tool body 104. In other embodiments, the rotating tool body may be rotated by other mechanisms such as gears driven by axial motion of the tool body 100 through casing 102. In addition, motor 106 or other rotating mechanism may be located in another part of the tool 100, such as within the rotating tool body 110, or outside of the tool such as higher up on the wireline 101 or above ground. A clutch may be used with the motor for protection in case the sensor pad hangs up during rotation and stops rotating.

Generally, substantially all exposed parts of sonde 100, including rotating tool segment 110 and sensor pad 113, are smoothed and rounded to prevent sonde 100 from hanging up or snagging against any protrusions, tubular ends, tubular lips, seating nipples, gas lift mandrels, packers, etc., within a borehole.

In operation, and as described in more detail below, a sensor(s) within the sensor pad 113 detects the radial component of conductive fluid, such as water, entering or leaving the wellbore through the wellbore wall. Preferably, tool 100 is slowly moved axially at a speed such that, while sensor pad 113 is rotating, generally the entire or substantially all of the inner area of the wellbore wall portion to be measured is covered by the sensor area of sensor pad 113. Alternatively, the sensor may sweep across overlapping swaths of the detected spiral area to ensure full coverage of the borehole wall, even if the axial speed of the tool varies. Tool 100 may make one, two or more axial passes through a wellbore while logging measurements made with sensor pad 113. Normally logging may be performed from the bottom upward, but logging also may be performed while moving in the downward direction.

In one embodiment, the rotation rate of the rotating tool segment may be measured, so that a computer or log interpreter can determine if the tool stops rotating and thus determine the portion of the borehole inner wall not logged and over what depth interval that occurs.

Various embodiments disclosed herein include systems and methods for making, outputting, and interpreting the measurements from a multiple flow channel electromagnetic flowmeter sensor, where each flow channel is measured individually.

While previous embodiments sum the outputs from the entire multitude of flow channels, e.g., 15 flow channels, in a sensor, embodiments described below detect, output and analyze the measurements from each flow channel individually. This was found by laboratory experiment to be very useful, such as when gas was flowing up from below the current position of the measurement, the gas caused an actual movement of water back and forth in each of the multitude of flow channels. The sensor detected this water movement, which manifests itself as a large background noise, which effect is referred to herein as water sloshing. When the sensor output was summed in this situation of gas flowing up from below, the output detected the sloshing in all the channels, but any actual water inflow through the casing is typically only one or two channels. This situation resulted in a larger noise so the signal to noise ratio was significantly decreased. This resulted in a significantly larger inflow of water needing to be present before the water inflow could be detected. As discussed herein, unless otherwise understood from the context, the measurement of water inflow or water outflow includes the capability to measure the other.

To improve these measurements, and also to provide benefits in other areas as well (such as better resolution to determine the shape of the inflow, allow independent and differing calibrations of each flow channel, etc.), embodiments disclosed herein detect the output of each flow channel individually. In some embodiments, each flow channel is measured and processed completely independently of the other flow channels. In other embodiments, subsets of the full set of flow channels may be summed and detected. The following descriptions illustrate embodiments with 15 flow channels, but any number of flow channels could be used, such as a larger or smaller number than 15. For example, any specific number of flow channels between 2 and 30 may be used, or a number of flow channels outside this range may be used. Alternatively, subsets of the flow channels (such as 2, 3, 4, 5 or any other number less than the total number of flow channels) may be summed and then each subset detected individually. The flow channels may be exclusive to each subset, or the subsets of flow channels may overlay with each other. The sensor providing multiple measurements may be referred to as an array sensor, in distinction from a summed output sensor.

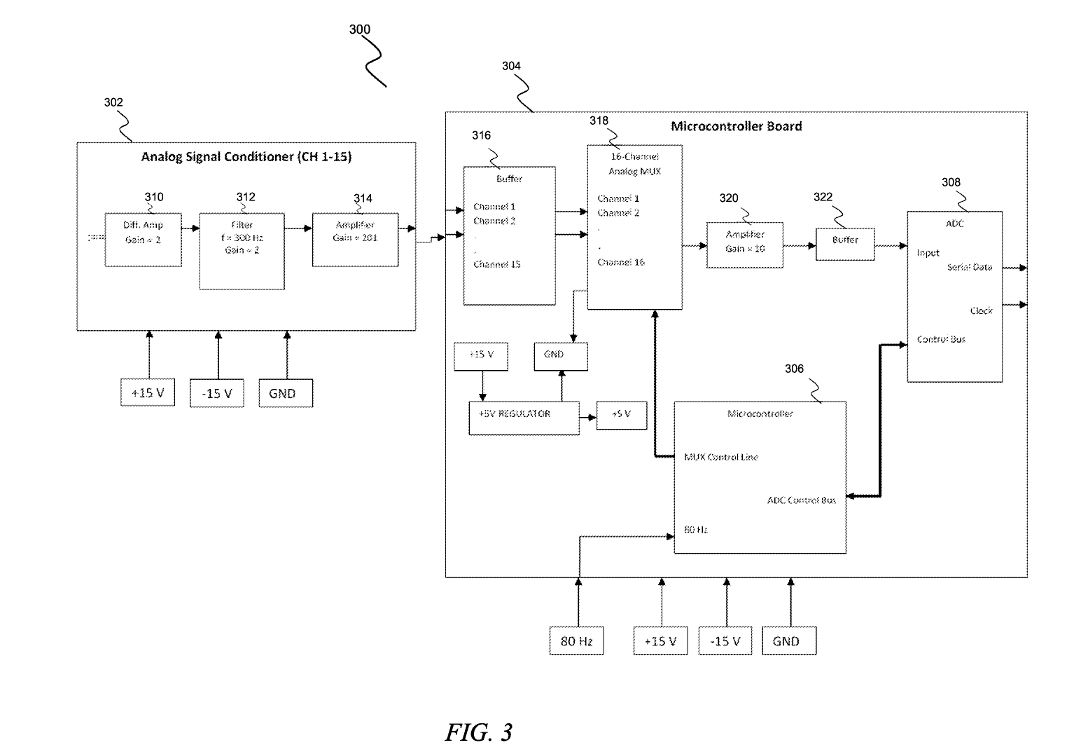

Electronically, each flow channel is measured and processed independently of the other flow channels. FIG. 3 is a block diagram illustrating the signal conditioning and control circuitry 300 for the array sensor data. The system comprises an analog signal conditioner 302 coupled between the array sensor electrode pairs and a microcontroller unit 304 containing a microcontroller 306 and an analog-to-digital converter 308. The analog signal conditioner 302 for each of flow channels 1-15 comprises two leads input to a differential amplifier 310. The two leads are coupled to one electrode pair in one flow channel, and provide the basic measurement voltage signal from that flow channel. The analog signal conditioner circuitry is repeated for as many channels as exist, which in this embodiment is 15 channels, and thus there are 15 analog signal conditioner circuits 302.

The analog signal conditioner circuit 302 operates as follows. The voltage signal from the flow channel measurement is input to a differential amplifier 310 with a relatively low gain, for example about 2 in this embodiment. This low gain generally keeps the noise relatively low. Alternatively, the gain may be any value between about 1.1 and about 3.0 or higher. Then the signal is input to a low pass filter 312 to reduce the noise before further amplification. Next the signal is amplified 314 with a sizable gain, for example a gain of about 201, after the noise has been reduced by the filter. Alternatively, this gain may be any value between about 50 and about 400 or a value outside this range.

Next the signals from the plurality of flow channels are input to the microcontroller board 304 for analog-to-digital conversion. The analog signals are buffered 316, and then connected to the inputs of the analog multiplexer (MUX) 318. The MUX 318, upon command from the microcontroller 306, outputs the analog signal from the appropriate channel to an amplifier 320 (with a gain of 10 in this embodiment). Alternatively, this gain may be any value between about 2 and about 50 or more. The signal then is buffered in the buffer 322, and input to the analog-to-digital converter (ADC) 308. The ADC 308 converts the incoming analog signal into a digital signal, which is output for use in computing the measurement value. The measurement value is the difference of the two ADC outputs from a given flow channel (1 to 15), when the electrical current in the coil is going in opposite directions.

In practice, the user can be provided the option of reading ADC values a user-set number of times, such as 4 times, and averaging the results, which generally reduces the noise. The noise reduction takes place due to the averaging of the true signal and noise, because the signal is present repeatedly and noise is random, thus canceling itself out. Alternatively, the signal may be averaged any number of times between about 2 and about 100 or more.

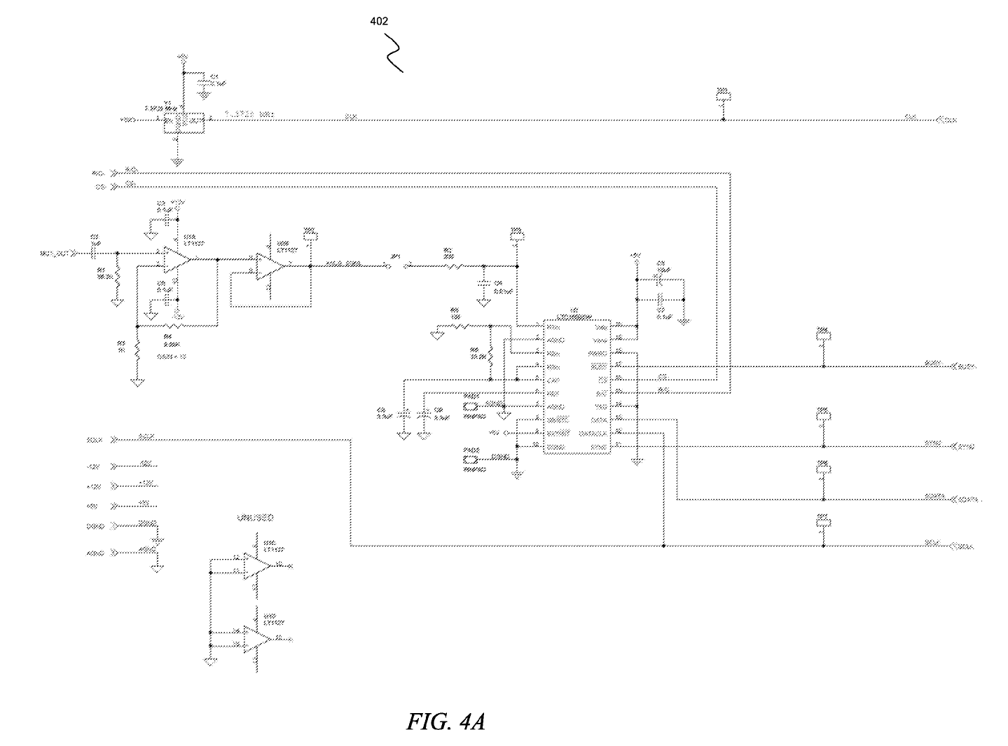

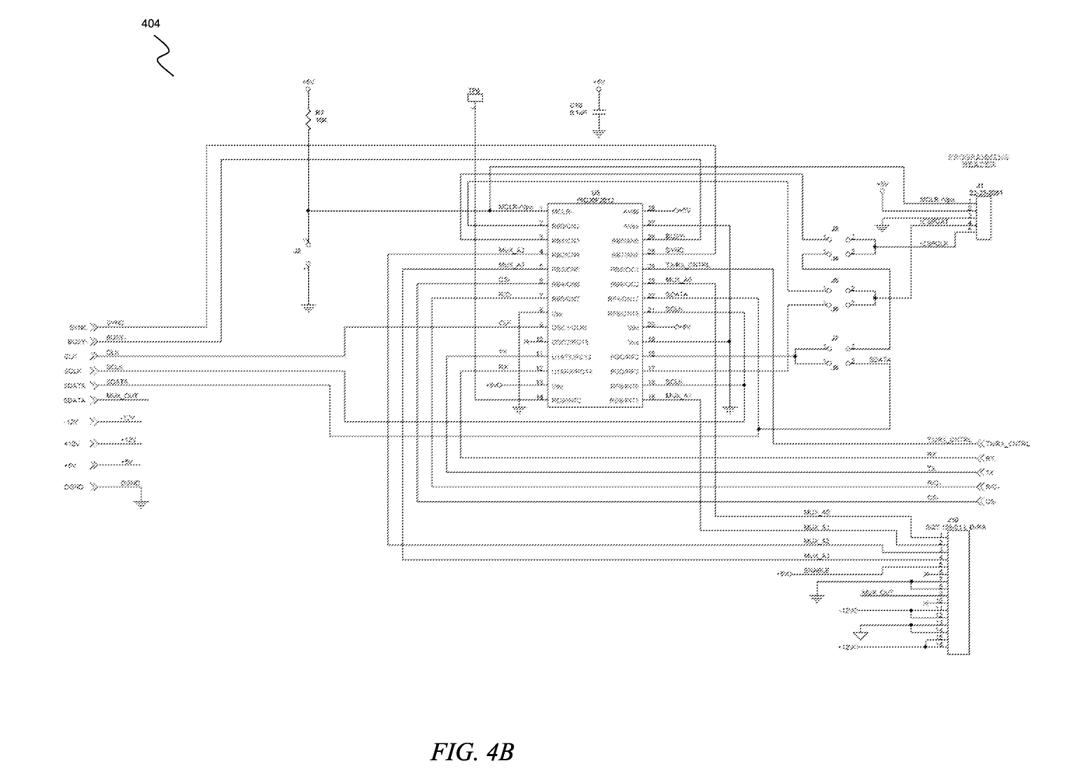

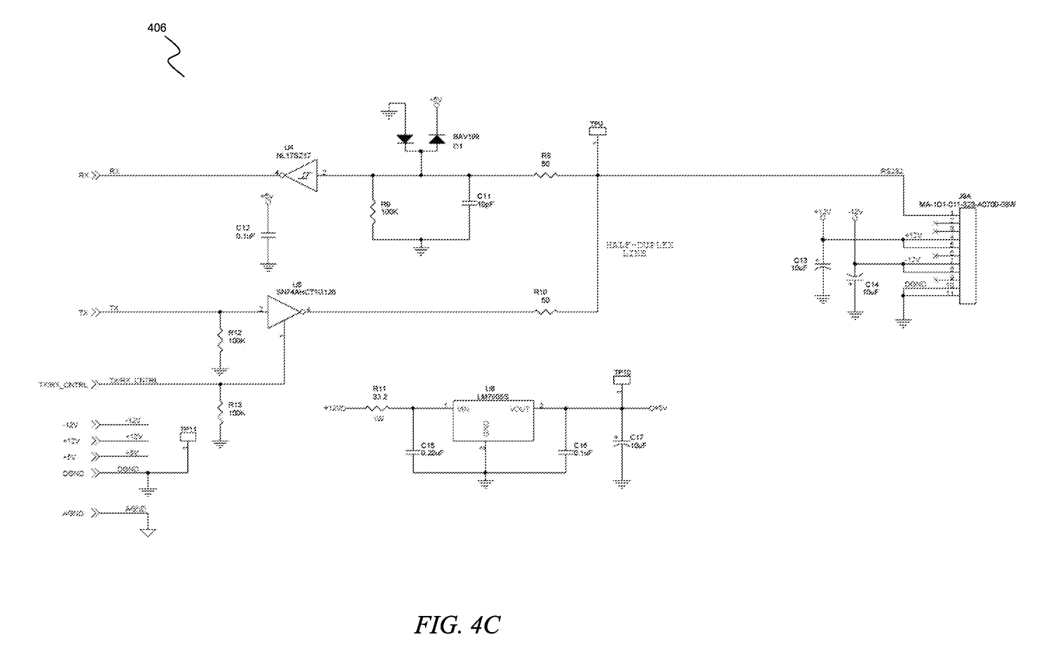

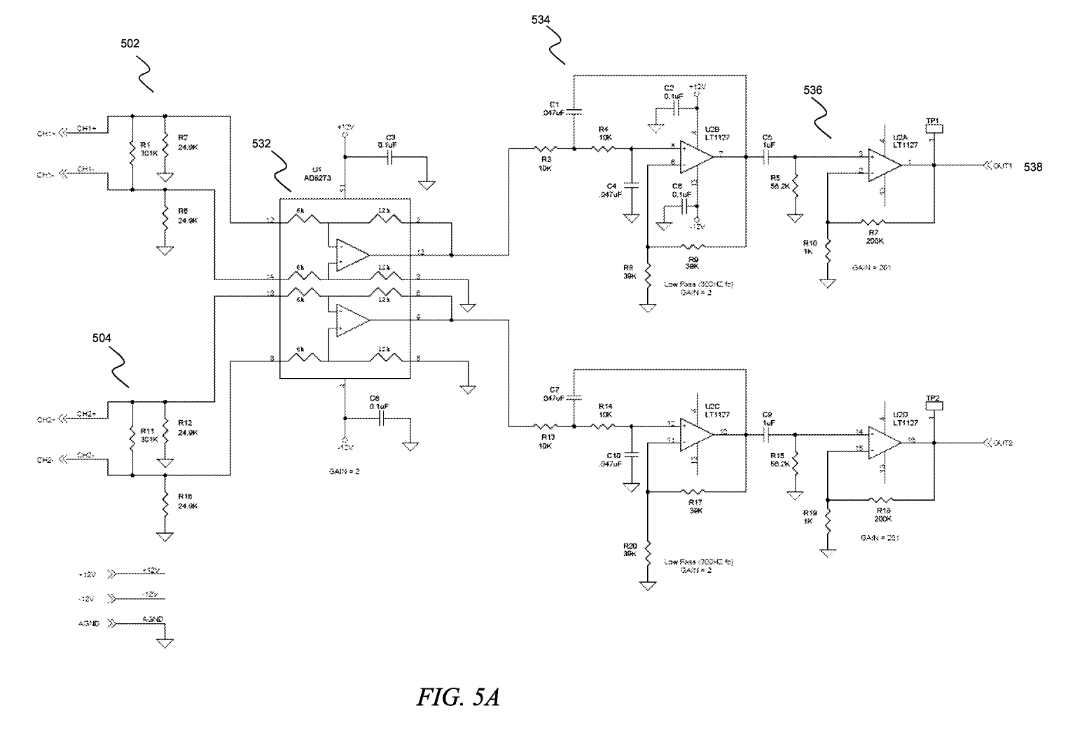

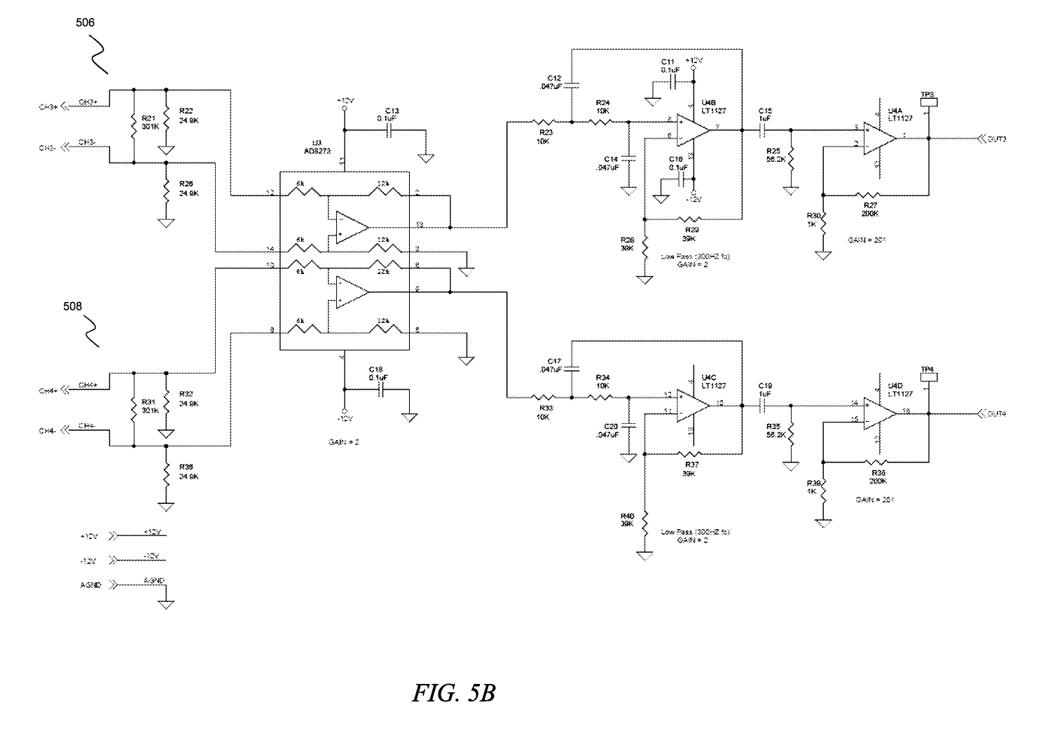

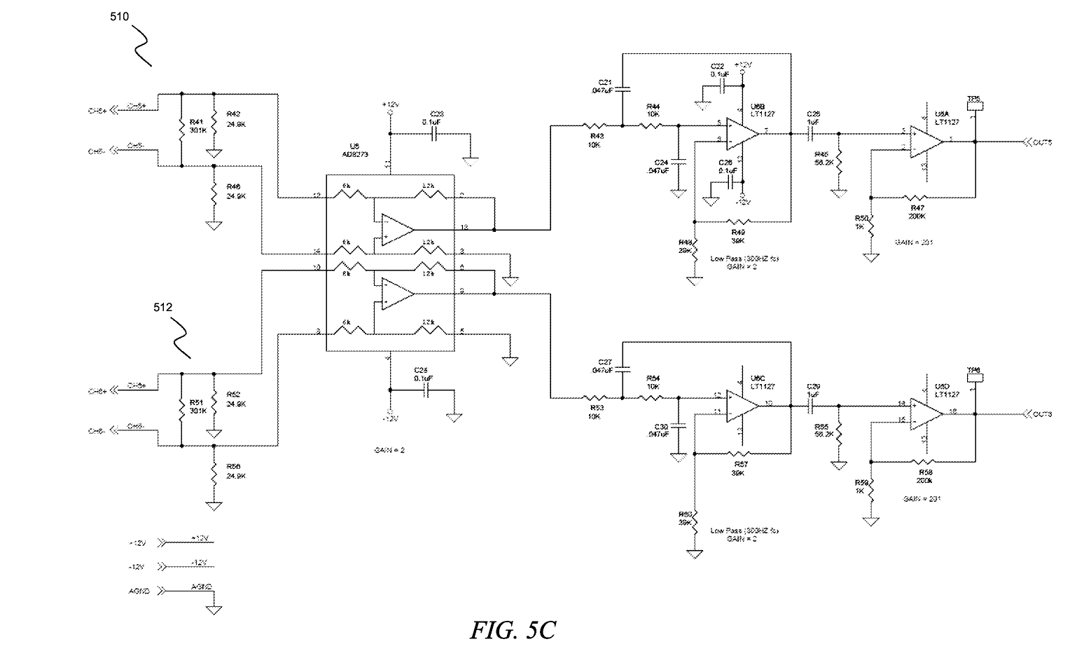

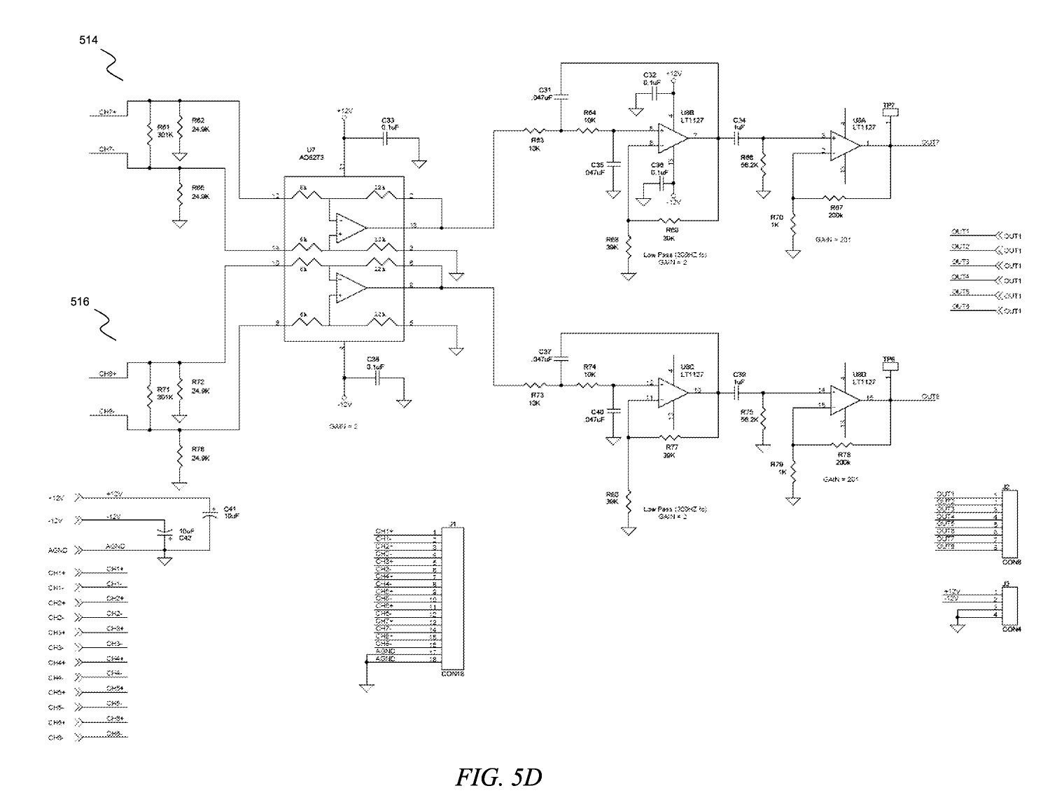

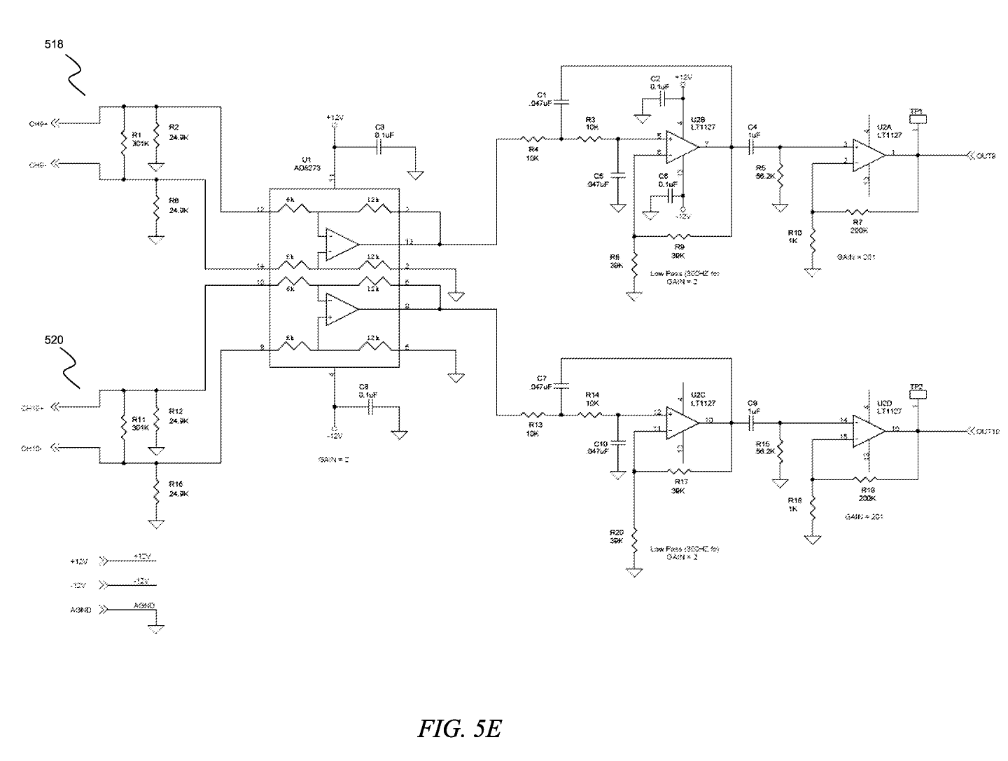

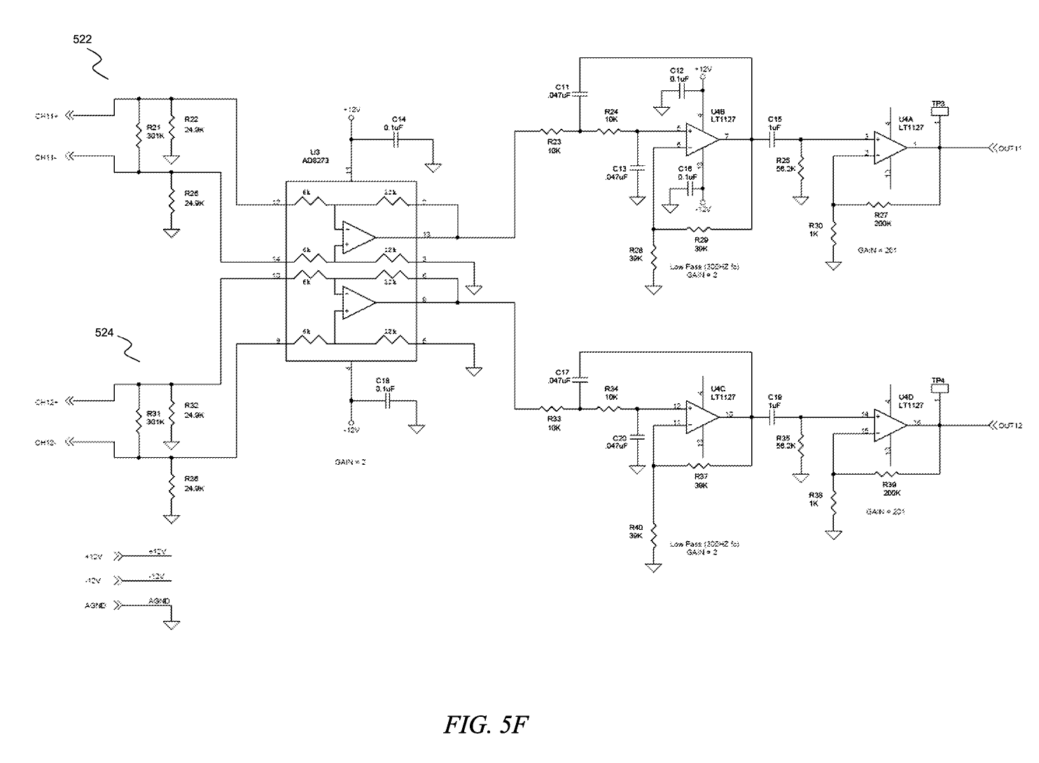

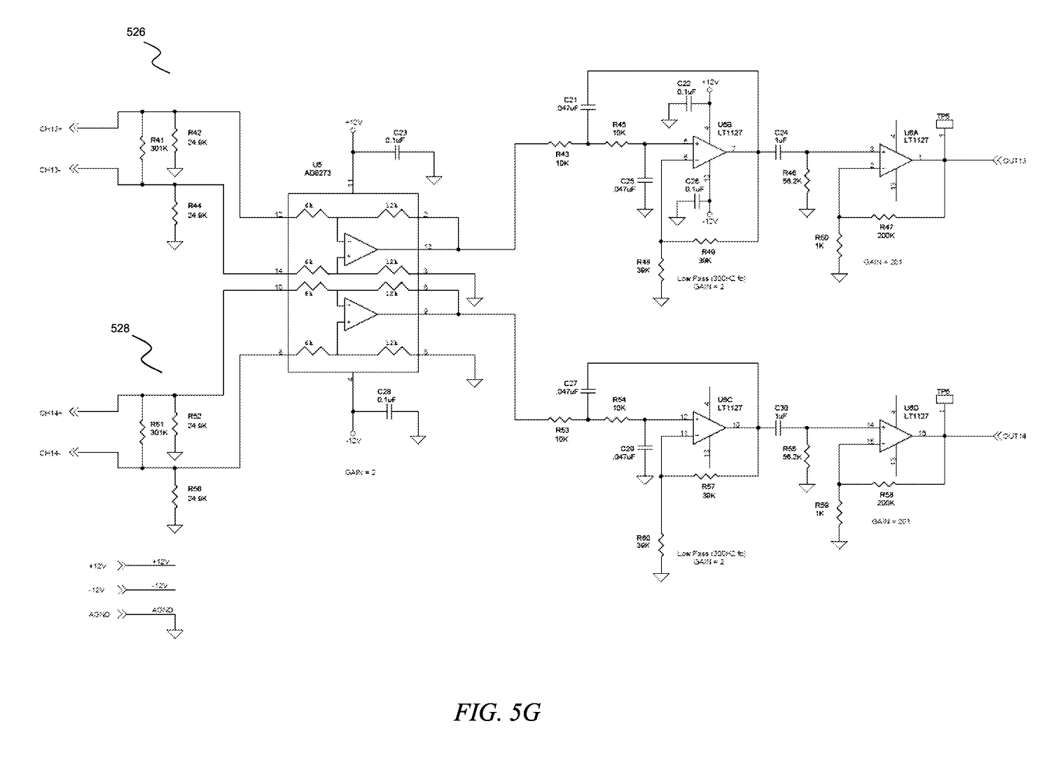

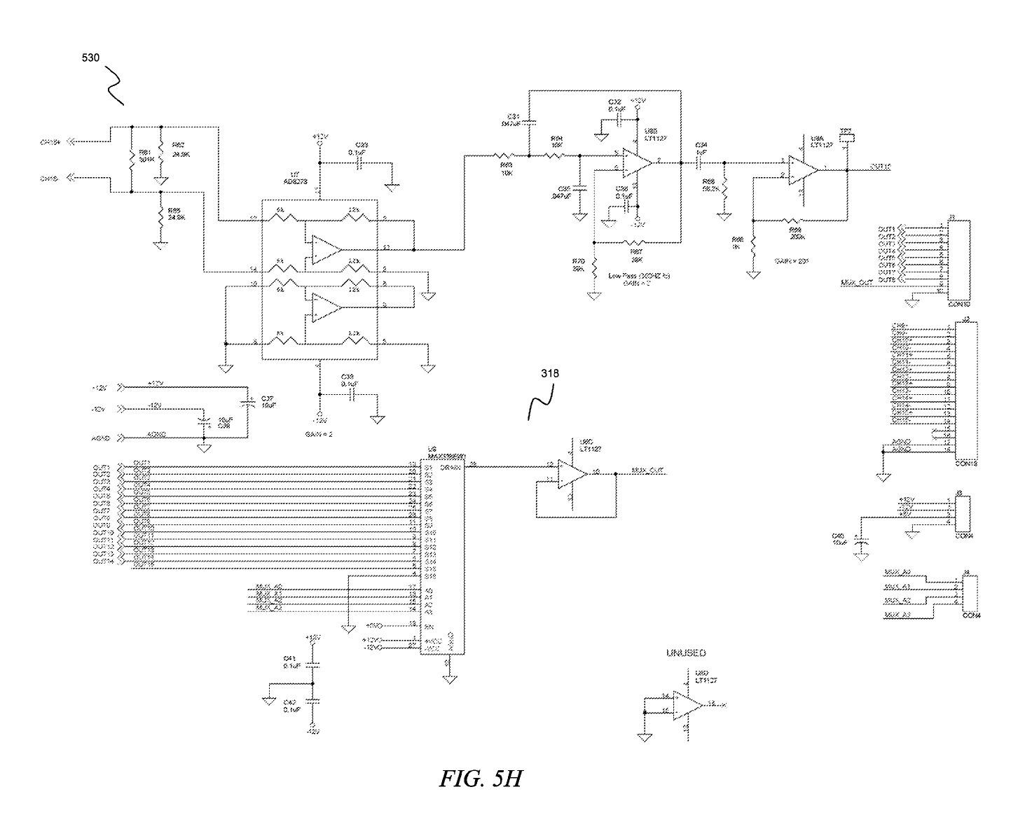

FIGS. 4A-4C are schematic diagrams 402, 404, 406 of the microcontroller board 304 containing the analog-to-digital converter circuitry and the microcontroller. Generally, the microcontroller 306 controls the MUX 318 and the ADC 308. Note that a portion of the circuitry on the microcontroller board 304 is shown in FIG. 5H. These schematics provide one specific embodiment of the system shown in FIG. 3, and other embodiments and variations are readily discernable as being within the scope of the present invention.

FIGS. 5A-5D are schematics illustrating the circuitry of flow channels 1 through 8, 502, 504, 506, 508, 510, 512, 514, 516, respectively, which may be disposed on one analog board, and FIGS. 5E-5H are schematics illustrating the circuitry of flow channels 9 through 15, 518, 520, 522, 524, 526, 528, 530, respectively, which may be disposed on one analog board. The schematics for each of the 15 flow channels are essentially the same as each other. Following the input voltage for channel one 502 in FIG. 5A to describe the function of the analog electronics, the voltage difference between the two electrodes in channel is input to a differential amplifier 532 with a relatively low gain, for example 2 in this embodiment. This low gain generally keeps the noise relatively low. Then the signal with low gain is input to a low pass filter 534 to reduce the noise before applying more amplification. Next the signal is amplified 536 with a sizable gain, in this embodiment a gain of 201, after the noise has been reduced by the filter 534. This amplified signal 538 is then output to the analog-to-digital converter circuitry on the microcontroller board 304 of FIG. 3.

FIG. 5H, which illustrates the analog signal conditioner circuitry for channel 15, also illustrates the analog multiplexer 318 on the microcontroller board. In this circuit, the analog multiplexer (MUX) 318, upon command by the microcontroller 306, sends the analog signal from the selected channel to the ADC 308 for conversion from analog to digital. These schematics provide one specific embodiment of the system shown in FIG. 3, and other embodiments and variations are readily discernable as being within the scope of the present invention.

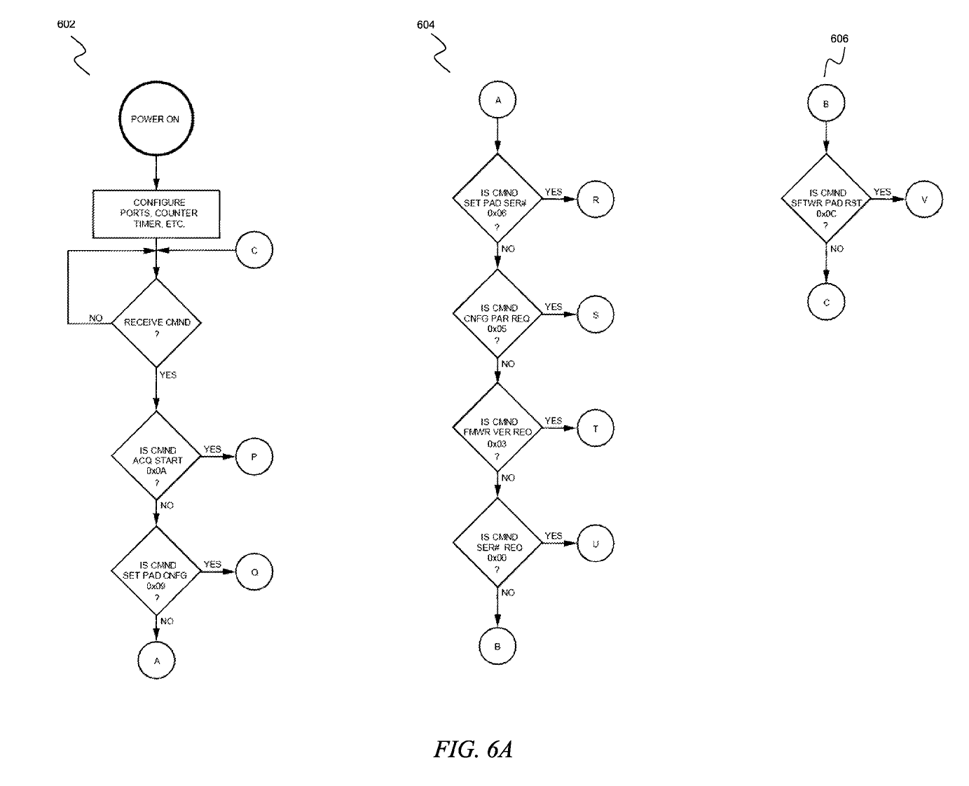

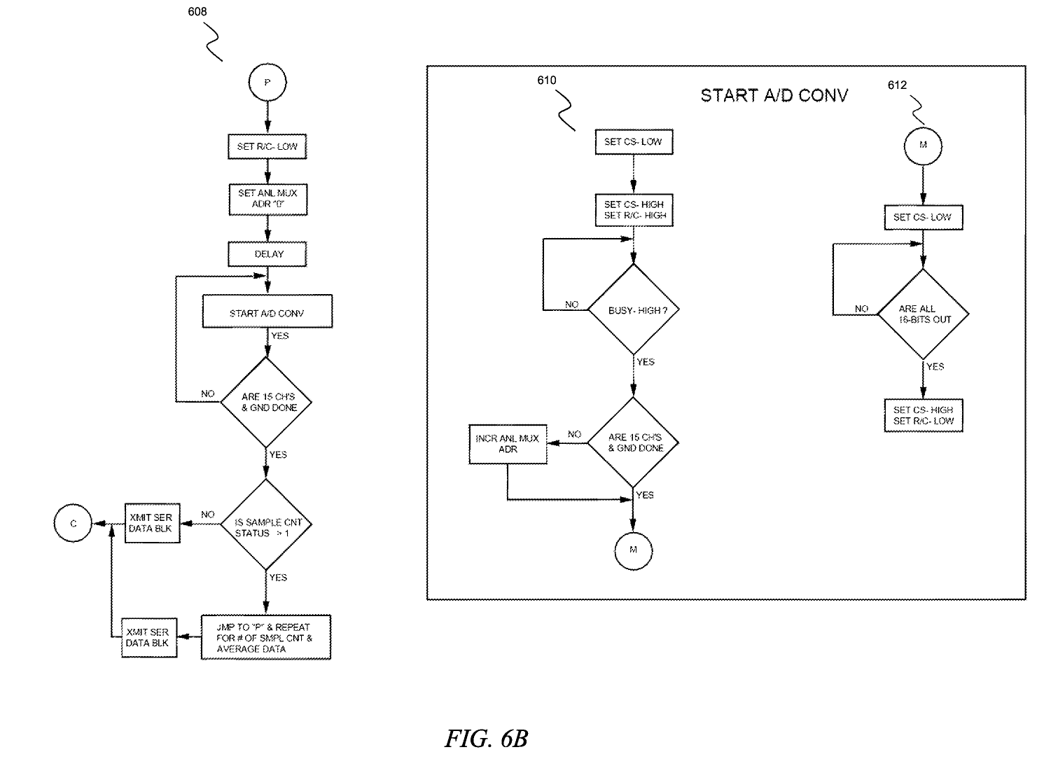

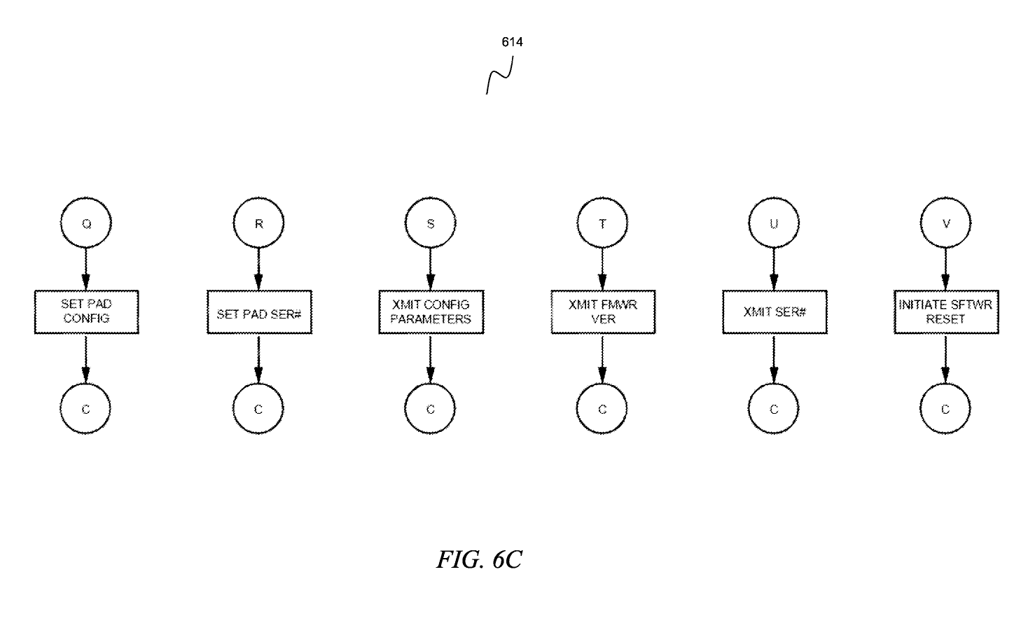

FIGS. 6A-6C are flowcharts 602-614 for the microcontroller firmware. Several primary functions are performed by the microcontroller 306, in which the microcontroller: (1) controls the order in which the analog signals are passed to the A/D converter; (2) controls the A/D converter to facilitate the digitization of the analog signals to digital signals; (3) receives commands from external electronics and acts on those commands; and (4) formats data in blocks ands send it out serially in RS-232 data format. Alternatively, other transmission formats, serial or parallel, packet or non-packet, may be used, such as GPIB, Ethernet, USB, FireWire, etc. The data is then processed by other electronics in the tool body, which are well known in the art, for transmission to the surface for recording by recording equipment and further processing and analysis.

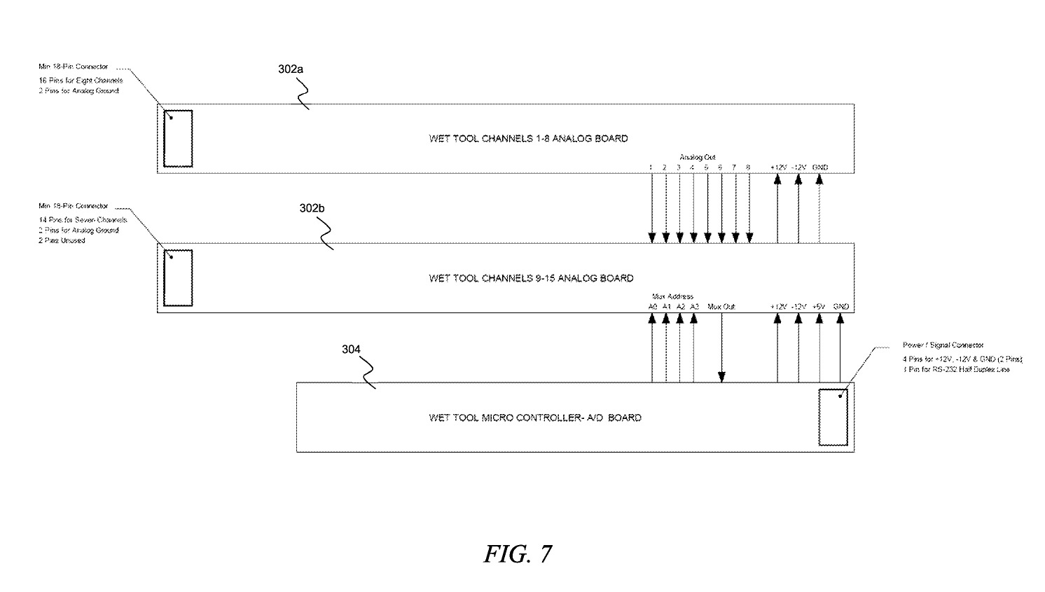

FIG. 7 is a block diagram showing the interconnection of the microcontroller 304 and two analog signal conditioner boards 302a, 302b for the water entry tool (WET). These three boards, containing the analog and digital circuits described above, are connected to each other and mounted in the water entry tool sensor housing. Alternatively, the circuitry may be disposed on the boards in a different manner, and the circuitry may be disposed on one, two, four or more boards.

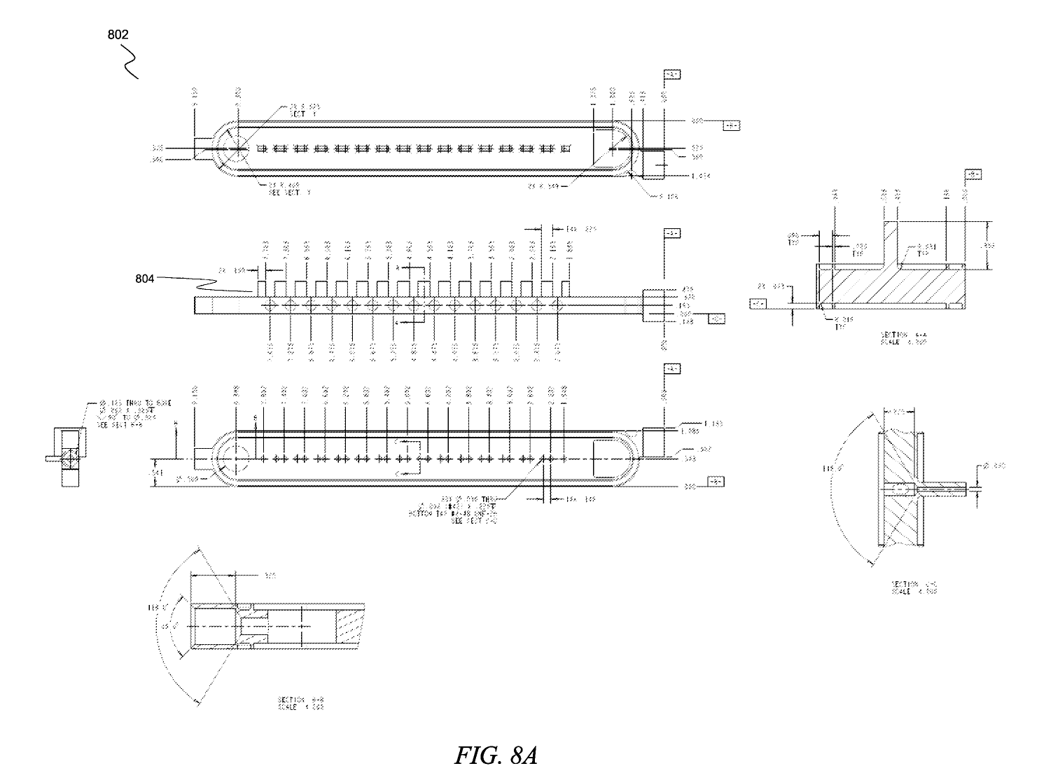

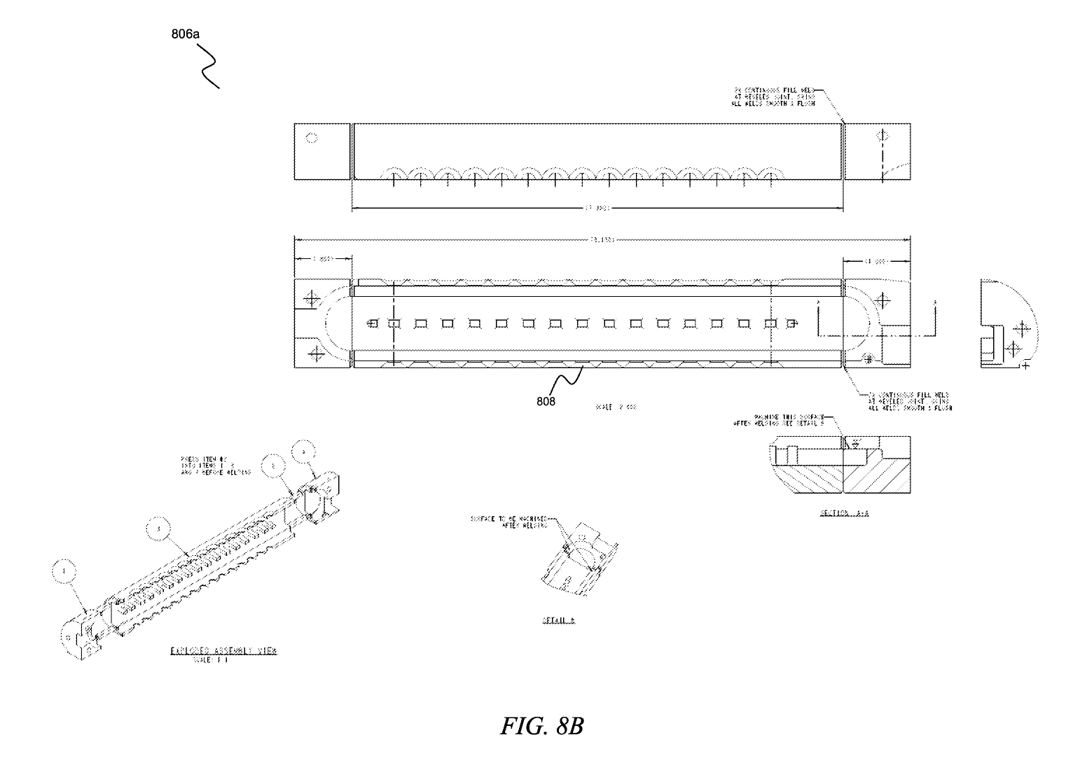

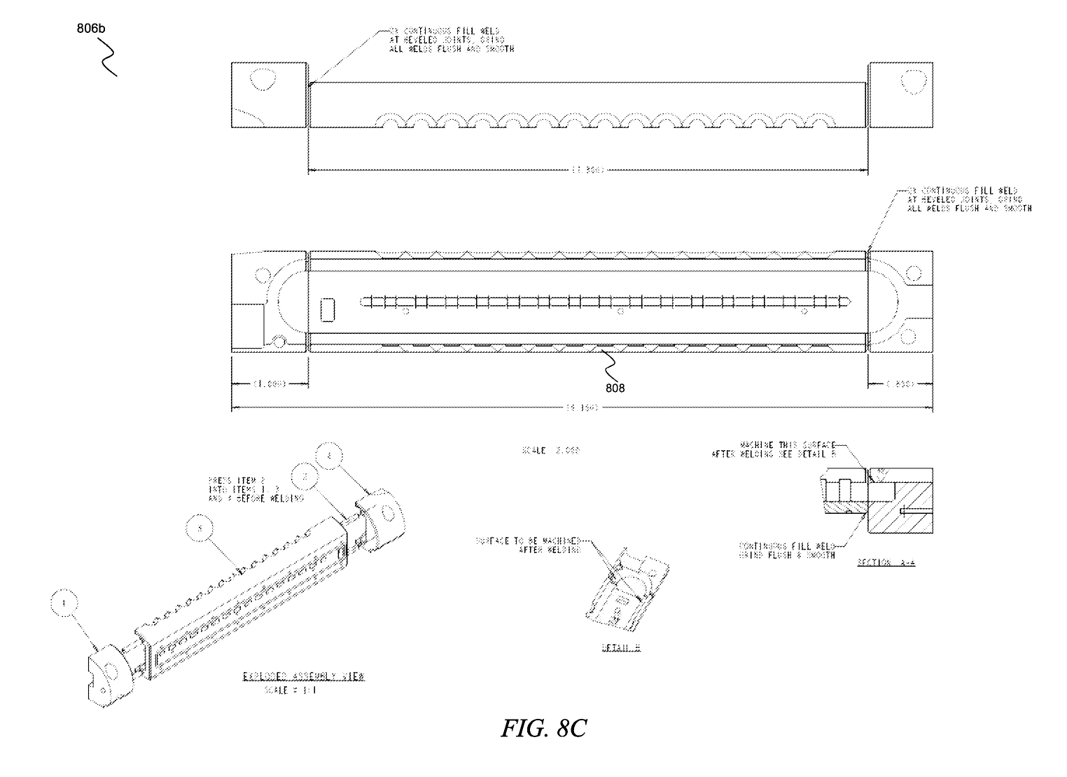

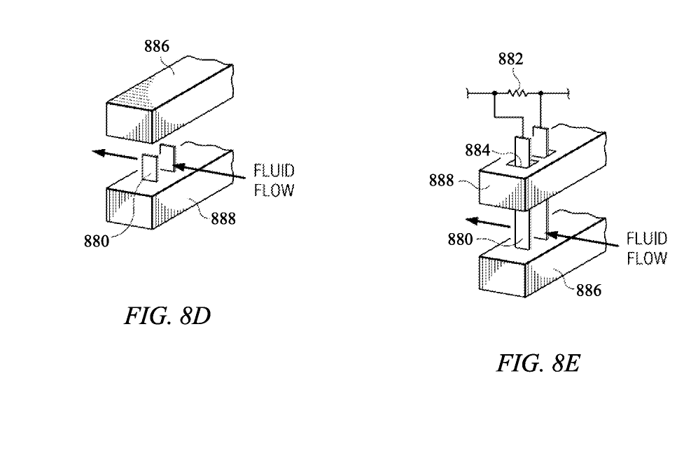

FIGS. 8A-8C illustrate an embodiment sensor housing for the flow channels and electrodes. FIG. 8A is a mechanical drawing of a plastic isolator block 802 comprising the flow channels that the water flows through, and the electrodes 804 embedded in the center of each of the 15 flow channels. FIG. 8B is a mechanical drawing of half of the core of the sensor 806a, and FIG. 8C is a mechanical drawing of the other half of the core of the sensor 806b. The two core halves 806a, 806b fit together with the isolator block 802 between. A pressure vessel or other housing for the electronic circuit boards is coupled to, for example, the left end of the sensor housing in FIG. 8B (which is the right side of the sensor housing shown in FIG. 8C). A pressure vessel may be used to maintain the electronics at atmospheric pressure. An O-ring seal may be used to couple the sensor assembly and the electronics housing, and a glass-to-metal or ceramic-to-metal feedthrough may be used to transfer the signals between the two housings. As shown in FIGS. 8B-8C, the input/output ports 808 are beveled to allow both for capture and sensing of a fluid flow area larger than the size of the flow channel itself, and for sufficient magnetic steel to remain in the region of the flow channel to act as part of the magnetic circuit for the electromagnetic sensor.

FIG. 8D illustrates an embodiment electrode configuration with permanent magnets 886 and 888 for the electrodes disposed in the array sensor. The magnets may be used with or without a surrounding core, as long as flow channels exist for guiding fluid to flow between the magnets. In this example the lower side of magnet 886 is the south pole face and the upper side of magnet 888 is the north pole face. The electromagnetic sensing operation of conductive fluid flow with electrodes 880 is described in detail in the patent applications referenced hereinabove. FIG. 8E illustrates another embodiment with permanent magnets 886, 888. Electrodes 880 are disposed in the gap between the north and south poles through openings 884 in permanent magnet 888. The electrode pair is electrically connected by resistor 882 and a voltage measured across the two electrodes is representative of conductive fluid flow in the gap between the two electrodes, again as described in detail in the patent applications referenced hereinabove. Any of the other relevant embodiment electrode/magnet configurations disclosed in these patent applications may be used in the array sensor. For example, in another embodiment a coil and magnetic material may replace permanent magnets 886 and 888.

There are many alternatives for the embodiments discussed herein that one of ordinary skill in the art would recognize as being within the scope of the present invention. For example, in the embodiment discussed above, the differential signal from each electrode pair is converted to a single ended signal referenced to ground. In an alternative embodiment, the signal from the electrode pair may remain as a differential signal throughout the processing circuitry. In an alternative embodiment, the circuit may include a separate ADC for each flow channel (such as 15 ADCs). The output values from the ADCs may be multiplexed after conversion for transmission to the surface, or they may be transmitted in parallel. In another alternative embodiment, a voltage-to-frequency converter (VCF) may be used instead of an ADC. The frequency signal may then be input into a counter, with or without a phase lock loop or delay lock loop, which then provides a digital output signal. That digital information may then be used to determine or calculate the sensor signal. This approach could be used with either an array sensor or with a summed output sensor. Depending on the specific circuit configuration, the sensors may be sampled at the sampling frequency at the same time or in sequence. If the sampling is done in sequence, the channels may be sequenced in any order.

An embodiment of the invention comprises the use of an independent set of analog electronics for each measurement flow channel. For example, if there are 15 flow channels, then 15 sets of essentially the same analog signal conditioner electronic circuit may be implemented. In an embodiment, the signal-to-noise ratio (SNR) may be increased or maximized through the use of a low initial gain, a subsequent low pass filter to reduce the high frequency noise relative to the lower frequency signal, followed by a much higher gain after the filter. In an embodiment, the output from the 15 analog signal conditioner circuits are multiplexed and input to an analog-to-digital converter. A microcontroller may be used to control the operation and timing of the multiplexer and the ADC, as well as any other circuitry benefiting from such control.

Once the data has been collected from the array sensor, or during collection, the data can be analyzed. For example, in an embodiment, flow rate into/out of the wellbore wall is determined from the array sensor data. First, the various sensor flow channels' responses versus conductive fluid (e.g., water) flow velocity are calibrated. The flow velocity is converted to flow rate based on the cross sectional area of each of the flow channels, and the responses of all the flow channels over all detected inflows/outflows are summed. This procedure may account for the rate of sampling of the flow channels, and also for the geometry of the sensor flow channels, which in an embodiment are a series of contiguous circular openings instead of one continuous open slot.

To obtain the flow rates, the well is logged. This is typically performed by lowering the tool to near the bottom of the well (e.g., 10 feet above the bottom of the well). The tool is then pulled upward while acquiring data. The portion of the tool containing the sensor is rotated at an approximately constant rotation rate while logging. A typical rate of rotation is about ¼ revolutions per second (4 seconds per revolution) and a typical rate of axial traversal is about 5 feet/minute. The logging speed along the axis of the well is controlled, typically so some degree of overlap occurs between the swaths covered by the sensor during each rotation. The depth and channel of each measurement point taken is tracked and recorded. Alternatively, the tool may be rotated at a rate of between about 1/16 revolutions/second and about 1 revolution/second, at a rate outside this range. Alternatively, tool may axially traverse the well bore at a rate of between about 0.5 feet/minute and about 25 feet/minute, or at a rate outside this range.

In an embodiment, a flow point map is generated from the log data. Each measurement point is converted to flow rate. For each measurement point, the previously (e.g., laboratory) derived calibration for each flow channel relevant to that measurement point is applied to convert the measurement to flow velocity.

This lab velocity calibration is typically linear:

Velocityij=Mi×Measurementij+Bi

where
Velocityij=the velocity in channel i for measurement point j
Mi=calibration multiplier constant for channel i (determined from lab calibration)
Measurementij=the measurement result for channel i and point j (difference of A/D output between the current in the coils going in the positive and in the negative direction)

Bi=offset for channel i (accounts for any non-zero measurement output when no flow is present, determined from lab calibration)

This velocity can be converted to flow rate by

Q=Velocity×Area×K

where
Q=flow rate, in say Barrels Per Day (BPD)
Velocity=average flow velocity through the flow channel, as determined from the calibration, in say feet per minute (FPM)
Area=cross sectional area of the flow channel, say in square inches (in̂2)
K=units conversion constant, to give the desired flow rate units.

If the cross sectional area of each flow channel is the same, as in one embodiment, then a linear calibration can be used to go straight from measurement to flow rate, such as:

Q=MRi×Measurementij+BRi

Where
Q=flow rate, in say Barrels Per Day (BPD)
MRi=calibration multiplier constant for flow rate for channel i (determined from lab calibration)
Measurementij=the measurement result for channel i and point j (difference of A/D output between the current in the coils going in the positive and in the negative direction)
BRi=offset for channel i for flow rate (accounts for any non-zero measurement output when no flow is present, determined from lab calibration)

In both cases the velocity and flow rate are signed and indicate the direction of flow. For example, a positive value of velocity or rate means flow into the well, and a negative value of velocity or rate means flow out of the well. In an alternative embodiment, the inverse may apply.

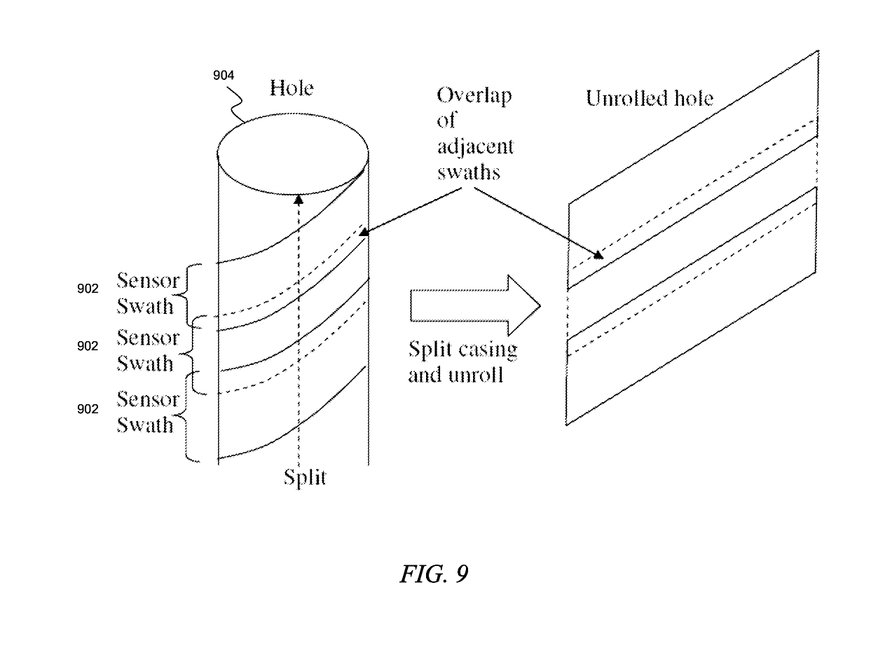

FIG. 9 illustrates the overlap of adjacent sensor swaths 902 in a conduit 904. For any overlapping bands of each measurement swath as the well is logged, a number of methods could be applied to account for the overlap. In one embodiment the greatest magnitude values of the overlapping parts on a point by point basis are used to create a non-overlapping flow points map. Using the largest magnitude values generally ensures that all flows are seen. This may be useful in cases, for example, where the axial movement of the logging tool was not uniform but jerky, and the jerking caused one of the rotations to miss an inflow or outflow that is located close to the edge of a swath.

In another embodiment, in the overlapping strip regions, two (or more) values from the two overlapping strips are averaged to determine an averaged value that is used. Yet another method of handling the overlapping strips is to use all the points from both rotations and account for the higher density of points in the overlapping strips when computing flow rate.

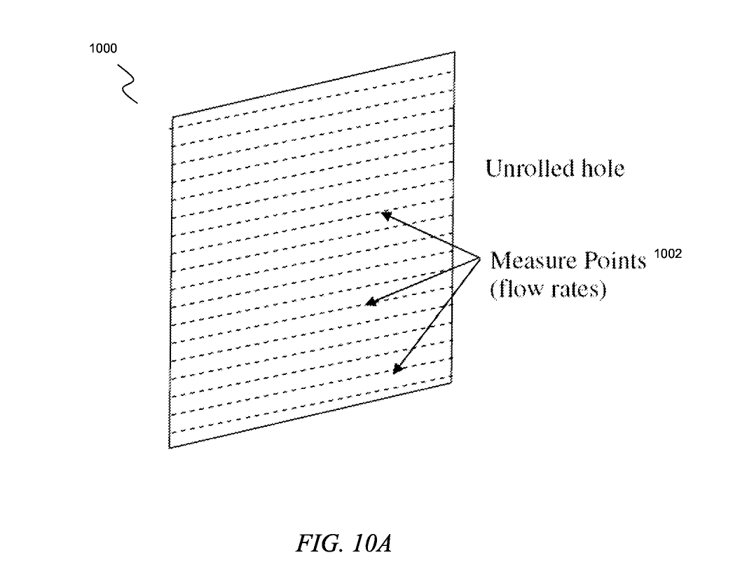

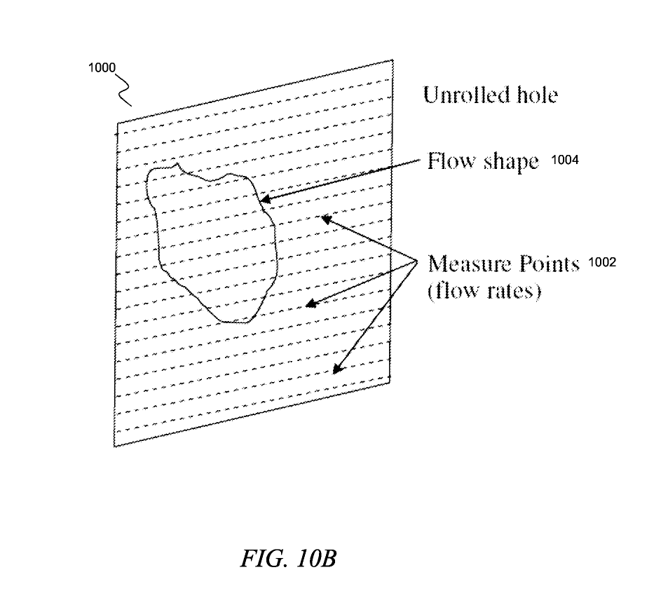

A flow points map 1000, consisting of flow rates at each measurement point 1002, is then generated as shown in FIG. 10A. From the flow points map 1000, each separate flow or flow group may be determined. All measurement points belonging to a single inflow/outflow may be grouped together. This is to identify an anomaly, such as a specific leak or injection. In general, this is done by determining the contiguous flow points on the flow points map 1000. The determination of the flow points within a given flow provides for an accurate determination of the flow rate for that flow.

Various methods of determining each separate flow are possible. In one embodiment, starting from the bottom-most (or upper-most) point on the flow points map, the map is traversed to the right (or left). The first water flow point is searched for by using a cutoff or threshold flow rate value (that may be user settable) in, for example, Barrels of Water Per Day (BWPD). A typical value might be about 4 BWPD, but could be about 1, 2, 3, or any between 5 and 10 or more may be used.

Once the first flow point is found, then a search is performed a (e.g., user settable) distance, Rn, in inches, for example, for another flow point with a flow above the threshold value. The search may be up, down, left, and right for a second such flow point. Any point within this search box meeting the flow cutoff is considered part of that one flow.

The search is continued within the Rn distance in all four directions of all flow points already found and include any newly found points in that one flow. The search then proceeds out Rn distance from those newly found point(s) looking for any other points above the threshold. The search is continued until all points within that one flow are found. The search thus looks for more flow points within a box with sides of 2Rn by 2Rn centered on each point of flow which is above a threshold. Alternatively, the search may look for flow points a different distance in different directions. A typical value of Rn is about 0.4 inches, although any value between about 0.1 and about 1.0 or higher may be used. The flow shape is thereby established by the flow points found.

In an embodiment, when computing flow, all the points within the flow shape having flow in the same direction as the direction of the large flows are included, whether or not they are above the threshold, as they may be and likely are contributing to the actual flow. This was determined to be beneficial in the laboratory. In another embodiment, only points above a given threshold are used.

In an embodiment, each flow is checked to ensure it has a minimum number of points, Fmin, and, if not, eliminate it as a flow group and denote is as no flow. This generally will eliminate spurious noise spikes from being interpreted as a real flow, because a real flow generally will contain the minimum number of points due to the size of the channel openings. Other methods of eliminating spurious spikes may be used, such as using a low pass filter, with a cutoff of, for example, 8 Hz.

An alternative method of determining a flow and its shape is for the user to manually analyze the data and determine the flow shape, and use all of the unidirectional flow points within that flow shape to calculate the flow rate for that flow. In an embodiment, the data is clipped to keep all points above a threshold flow rate, which may be user set and may have a value of, for example, 4 BWPD, 0 BWPD, or any other value, before the data is analyzed. One of ordinary skill in the art would recognize that other methods for determining the flow shape and which points are to be used in determining the flow rate are within the scope of the present invention.

The process is repeated to identify any additional flows in the log, for example until all flows have been identified. FIG. 10B illustrates an example flow shape 1004 generated by one of the above methods. The width of any inflow/outflow generally will appear wider than the true width by the diameter of the inflow mouth (+/−1 sampling interval). The diameter of the inflow mouth is typically 0.4 inches.

After determining the flows in the log, the flow rate for each flow is determined. The flow rate of each flow in the flow points map is determined from, for example, the flow shape of each flow. The data may be filtered prior to determining the flow rate. The flow rate is determined for each flow by applying the following procedure.

The total flow rate from a given flow can be calculated as follows:

Total Flow Rate=(Sum(RATEi)/Cs)×GF

Where
Sum(Ratei)=the sum of the flow rates of the individual measurement points in the flow (points in above flow points map within the shape of the given flow), BWPD

where
Ratei=the flow rate of the ith point where the i points are those within the flow shape for a given flow.
Cs=a correction for multiple sampling along a diameter of the flow channel inlet (equation given below), decimal (not an integer). Cs is the number of INTERVALS between samples (not number of samples) within the channel mouth diameter.
GF=Geometric Factor correction, a correction for the fact we are using a series of contiguous circular inlets rather than one single slot (equation given below), (decimal).

The equation for Cs is:

Cs=MouthDiameter/SampleInterval

where
MouthDiameter=Diameter of mouth of inlet to a flow channel. A typical value is 0.4 inch.
SampleInterval=Interval between samples in inches, decimal
SampleInterval=(pi×ODmeas)/(Period×SamplingFrequency)

Where
ODmeas=Outer Diameter that the outer face of the measurement pad sweeps out during its rotation around the borehole, inches. Will be close to the casing ID.
Period=Period of rotation of the sensor pad rotating around the borehole, seconds. A typical value might be 4 seconds.
SamplingFrequency=Frequency of sampling of the measurement for each channel, Hz (samples per second). A typical value is 80 Hz (samples per second).

Note that Cs is a decimal, and typically is not rounded or truncated to an integer. For example, a sampling rate of 80 measurements a second and a channel inlet mouth diameter of 0.4 inches would give a Cs:

Cs=40.743665432/ODmeas(inches)

Adding to these conditions a typical ODmeas of 4.050 inches would give a Cs value of:

Cs=10.0601

The equation for GF for a series of contiguous identically sized circular entrance holes is:

GF=4/pi=1.27324

In an embodiment detecting a generally rare case of a very small area inflow, e.g., less than the area of the mouth of a flow channel, GF=1.00 (unity). This generally will occur infrequently and in most situations the value of GF can be taken to be 4/pi.

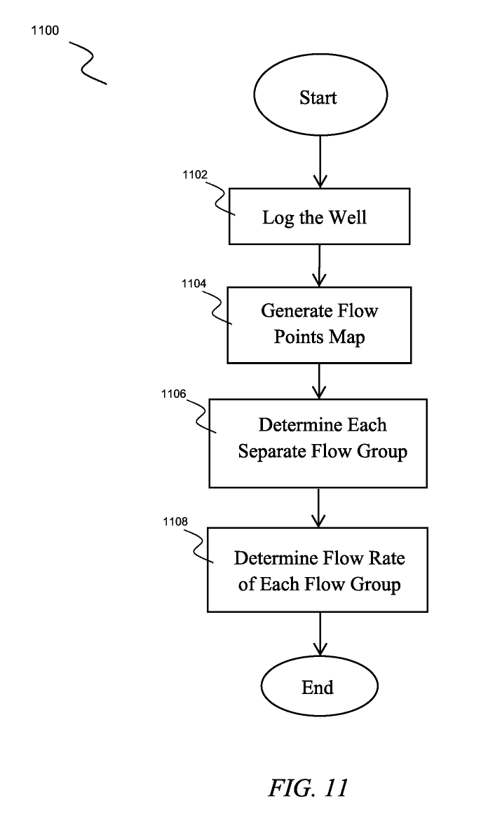

FIG. 11 is a flow chart 1100 illustrating the above-described procedure for calculating the flow rate.

The method starts by logging the well to collect the data 1102. Next, the flow points unfolded wellbore map in BWPD is generated 1104. First, the previously-determined (e.g., laboratory) calibration is applied to each flow channel. This may be a linear calibration with an offset and a multiplier. The A/D measurement units are converted to BWPD for each of the 15 flow channels. This data is signed (+,−) for indicating inflow or outflow.

For each overlap strip, one on top and one on bottom of each swath, the largest magnitude of the two overlaps is taken as the value for that point. This generally is done on a point-by-point basis, and generally compensates for the case in which one of the sweeps misses a flow.

In the next step 1106, the separate flow groups are identified by searching all contiguous flow points on flow points map, and accounting for inflow versus outflow. The search starts from the bottom of the flow points map and proceeds along the string of data from the lowest flow channel on the flow points map. The search looks for the first water flow, using a user-settable cutoff in BWPD (e.g., 4 BWPD).

From the first point with flow above the threshold, the search looks in all four directions a user-input distance of Rn (inches) for another point flow above the threshold. Any point within this search box meeting the flow cutoff is considered part of that one flow. The search continues searching within the Rn distance in all four directions of all flow points found. Any new points found over the threshold are included in that one flow, and then the search goes out Rn from the newly-found points looking for more flow points. This process is repeated for all identified flow points. The search effectively looks within a box of 2Rn by 2Rn centered on each point of flow for more flow points.

The number of points along a given channel sweep corresponding to Rn is:

N=Period×SampleRate×Rn/(PI×ODmeas)
where Rn and ODmeas are in inches, period is the period for one rotation of the sensor pad, the SampleRate is the sampling rate of the measurement (typically 80 samples/sec), and ODmeas is the Outer Diameter of the sensor pad face rotating around the borehole in inches.

In this case N is for a half box width, not the full box width. Also, the along-casing-axis distance is quantized in units of 0.4 inch (channel mouth diameter).

In an embodiment, the number of flow channels up, and down, Naxis, is:

Naxis=Rn/0.4, with result rounded up to next higher integer

In this case Naxis is for a half box length, not the whole box length.

In an embodiment, 0.4 inches is used as the default for Rn.

Each flow point (BWPD) in the flow points map is thus identified as no flow, inflow or outflow, and identified whether it is part of a flow group, along with the flow group number.

Each flow group is checked for a, e.g., user settable, minimum number of flow points Fmin. If not, the flow group is eliminated as a flow group and denoted as no flow. In an embodiment, a default for Fmin is Integer(Cs), with any decimal rounded down to next lower integer.

The next step 1108 in the method is to determine the flow rate in total BWPD of each flow group found in the previous step. The flow rate for each flow group is separately determined by first adding the BWPD of all flow points within a given flow group together. Then the data is corrected for multiple samplings within one diameter of inflow mouth by dividing by Cs, where:

Cs=MouthDiameter(inches)/Interval between two samples(inches)

In an embodiment, Cs=40.743665432/ODmeas, where ODmeas is the outer diameter of the rotating sensor pad face around the inside of the borehole, in inches, with a frequency of 80 samples/sec, a mouth diameter of 0.4 inches, and a period of 4 seconds.

Alternatively, the sampling frequency may be set between about 8 samples/sec and about 1,000 samples per second, or at a rate outside this range.

To correct for using round contiguous inflow mouths (as opposed to a continuous slot), the result is multiply by 4/pi (about 1.27) to make a flow geometrical factor correction.

The final result is the total flow rate for a given group flow. This process is repeated for each group flow. Generally, a well sketch or tubing detail will provide the ID(s) of the casing being logged and analyzed. Again, any inflow or outflow on the flow point map will show up as about 0.4 inch wider (flow channel mouth diameter) than the actual flow width (+/−1 sampling interval). In an embodiment, the above analysis accounts for the possibility of spurious spikes in the output signal in, for example, circuit logic, digital signal processing, or the like.

In an embodiment, a flow points map is generated, the map containing flow rates (or some indication of flow rates) at various measurement sample points around the borehole. The borehole can be visualized and analyzed as being cut longitudinally and rolled out flat. Each flow channel is calibrated individually, and the calibrations are applied to generate the flow points map.

In an embodiment, the map is searched for flow groups and using a threshold applied to each point to determine whether the flow point exceeds the threshold. If so, then the point is part of a flow group (contingent upon other conditions). The map is searched around that flow point such as by using a user defined distance Rn and searching Rn distance up and down, left and right (a square 2Rn on a side centered on the flow point) for any other flow points exceeding the threshold. If any points over the threshold are found they are included in the flow group. A square around that new point is then searched for flow points. The searching is continued until no more new points are found. The resulting points then define the shape of that flow group. Of course other search shapes than a square could be used, such as a circle, rectangle, ellipse, a regular or irregular-shaped polygon, and the like. In an embodiment, a threshold is used to require any flow group has a minimum number of points in it to be considered a group, as otherwise a large noise spike in one or a few points could erroneously be designated as a group.

In an embodiment, searching for flow groups is done by a user manually setting the shape of the flow group(s), such as by looking at the data points and then making the shape determination. Of course any other set of criteria may be used for determining inclusion of a point in a flow group.

In an embodiment, correcting for multiple measurement sampling of a same point or region is performed for by dividing by the appropriate correction factor Cs (number of sample intervals divided into the diameter of the mouth of the flow channel, which may be decimal and not necessarily an integer).

In an embodiment, geometrical correction to the flow detected and calculated is performed by multiplying by a geometrical correction factor, GF, which for most shapes of flow, such as a geometry of contiguous circles instead of a slot, is GF=4/pi (about 1.2732). Other inflow geometries would have a different geometric correction factor value. If the shape of the inflow is less than the diameter of the inflow mouth, then the value of GF is unity (1.00).

In an embodiment, the total flow rate within one defined flow group is calculated by summing all the flow rates within that group, dividing by the appropriate multiple sampling factor Cs, and multiplying by the appropriate geometric correction factor GF.

In an embodiment, sensor swath overlap in generating the flow points map is accounted for by taking the greatest magnitude values of the overlapping parts on, for example, a point by point basis, and using those values to create a non-overlapping flow points map. Alternatively, sensor swath overlap in generating the flow points map is accounted for by taking the average of two (or more) values from the two overlapping strips. Alternatively, sensor swath overlap in generating the flow points map is addressed by using all the points from both rotations and accounting for the higher density of points in the overlapping strip when computing the flow rate.

In an embodiment, spurious spikes are eliminated or removed by checking the number of points within a flow group and accepting as a flow group only those flow groups having a certain user-set (or otherwise determined) minimum number of points, and eliminating as a flow group any potential flow group that does not have this minimum number of points in it. Alternatively, spurious spikes may be eliminated by using a low pass filter.

The significantly increased vertical and circumferential resolution (one flow channel mouth diameter (e.g., 0.4 inch) provided by the array sensor allows the use of the shape of a water inflow/outflow flow group in diagnosing associated well anomalies/problems.

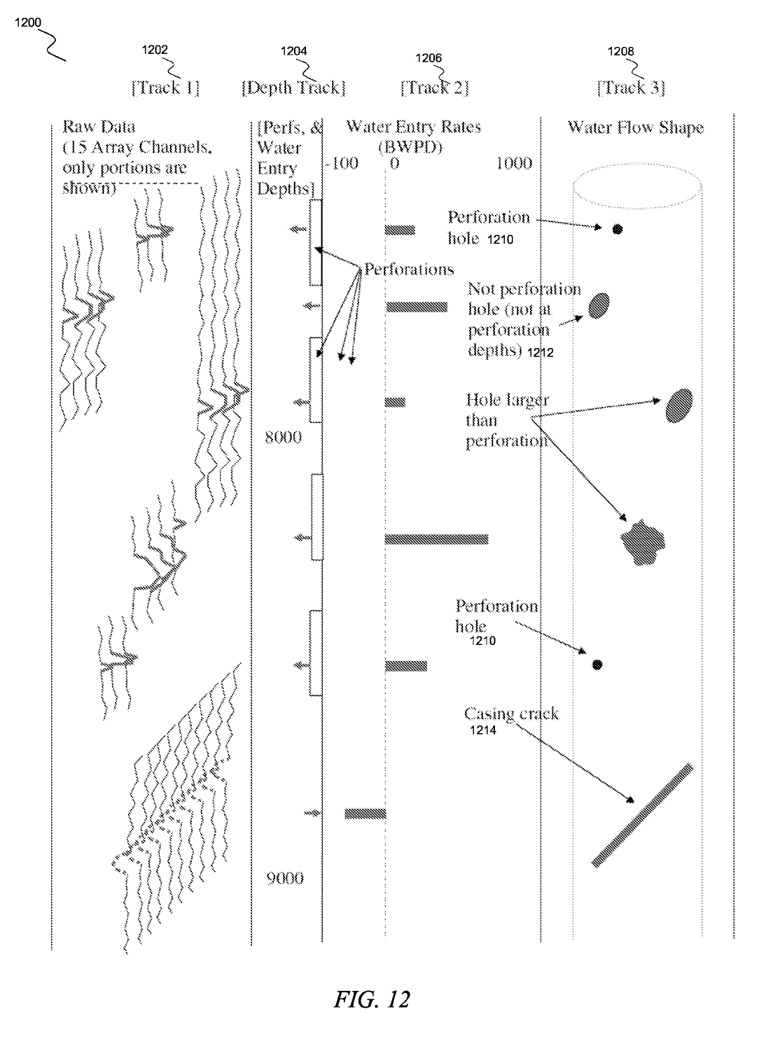

Various examples of using the shape of the inflowing/outflowing water derived from the array sensor log to diagnosis anomalies in a well are discussed below. These examples are not all inclusive, and one of ordinary skill in the art will readily recognize that other applications may be found. FIG. 12 illustrates several of these examples.

FIG. 12 illustrates a field print 1200 providing an indication of flow rate and the shape of the area through which the water is entering/exiting the borehole wall. Track one 1202 illustrates the output from all 15 channels (raw data) versus depth. In the figure only some of the channels are shown for simplicity of illustration. In an embodiment track one charts the A/D outputs versus well depth. In an embodiment, the traces are black lines that turn to solid blue lines where there is water entering the borehole. This may be done using a threshold cutoff to determine where the entries are and thus where to color the curves blue. Water exiting from the borehole wall is the same except it is shown with a dashed blue line, and again using a cutoff threshold, but with a negative number because the water outflow has a different voltage sign from water entry.

In the depth track 1204 shown in FIG. 12, the perforations are shown, as well as the water entry depths. Direction (inflow or outflow) is indicated by the direction of the arrows. In this embodiment the flow rate is not indicated, but may be shown in another embodiment. The arrow is placed at the center depth of the water entries/exits.

Track two 1206 provides an indication of the water flow rates and direction (entry versus exit). This track may show the flow in absolute BWPD, or the rates may be shown in relative units. The units may alternatively be millivolts based on the measured flow channel signals. The flow rates may be derived through integration or summing of pixel area times velocities (velocity calibrated from voltage).

Track three 1208 shows the (approximate) shape of the area the water flowing through the casing wall. As discussed above, the shape may be determined from the rotation rate of the sensor pad against and around the casing wall, the logging speed, and the number of entry/exit pixels. The orientation of a water flow relative to the high side of the casing can be determined by using auxiliary measurements indicating the orientation of the logging tool during the logging job. If the direction of the high side of the hole is determined (for example with a sensor), then the shapes can be positioned on a casing wall outline oriented with the high side in a given direction, such as to the right. Alternatively, if the direction of the high side of the hole is not known, the shapes can be positioned on a casing wall outline, but without specific orientation.

As a specific shape example shown in FIG. 12, a water inflow having the approximate size and shape of a perforation hole (approximately round, around 0.3 inch in diameter) 1210 where perforation holes are known to exist would likely indicate that a perforation hole is producing the water.

As another example, a water inflow having a larger size but the approximate shape of a perforation hole where perforation holes are known to exist would likely indicate an enlarged perforation hole due to production of water. Generally, enlarged perforation holes due to high rate water production are common.

As another example, a water inflow having a smaller size than a perforation hole would likely indicate a pinhole leak, probably due to corrosion.

As another example, shown in FIG. 12, a water inflow where no perforation holes are listed as existing likely indicates a casing leak 1212, probably due to corrosion. Another, less likely possibility, is unlisted perforations. Not all oil and gas companies maintain accurate records. Additionally, on occasional, a service company providing the perforation service will accidently shoot the perforation holes at a different depth than intended and thus be different from those listed in the well records.

As another example, a long thin water inflow, such as that shown in FIG. 12, perhaps several feet or more in length (2 or 3 feet and up to 20 feet or more), would likely indicate a casing split or crack 1214.

As another example, a water inflow at a casing collar (the joint between two adjacent pieces or joints of casing pipe) location likely indicates a connection leak. Also, a water inflow occupying a significant portion or the full 360 degree circumference at a depth may indicate a collar leak. A casing collar log(CCL) measurement can be used to determine if a collar is at the depth of the water inflow. Generally, water leaks at casing collars are common.

As another example, a water inflow from a large massive area would likely indicate large scale corrosion of the casing.

In an embodiment, the depth location of tubing leaks can be determine by inserting a plug in the bottom of the tubing, pumping water into the tubing, and generating a log with the array sensor while pumping water into the tubing to determine the depth location of the outflow of water. This outflow depth is the depth location of the tubing leak.

In an embodiment, the likely depth location of produced water from a well can be determined by pumping water into a well, and generating a log with the array sensor over the casing while pumping water into the casing to determine the depth location of the outflow of water. The outflow depth is the likely depth location of the water production in the well. Generally, water tends to flow out of a well at the same depth as it was produced from the well.

An advantage of the array sensor is the increased axial depth resolution and circumferential resolution versus that of a summed sensor. The ability to determine depth location of water flows relative to perforation locations provides useful information. For example, if the array sensor shows the depth location of a water flow is at a different depth from the depth interval of known perforations, this indicates that a casing leak exists at the water flow depth.

As another example, if the array sensor shows the depth location of a water flow in a central portion of the depth interval of known perforations, this indicates that the formation itself is likely producing the water. As another example, if the array sensor shows the depth location of a water flow in the very top of the depth interval of known perforations, this indicates that the water is likely channeling downward from a shallower water bearing zone. As another example, if the array tool shows the depth location of a water flow in the very bottom of the depth interval of known perforations, this indicates that the water is likely channeling upward from a deeper water bearing zone, or that the water is coning upward.

In an embodiment, the shape of the water inflow is used to diagnose anomalies in a well. Perforation holes producing water are indicated by the water flow shape being one or more small roundish holes about the size of a perforation hole and at depths where well records indicate perforation holes exist.

In an embodiment, a high flow rate washed out perforation hole producing water is indicated by the water flow shape being significantly larger than the size of a perforation hole but at depths where well records indicate perforation holes exist. In an embodiment, a pinhole leak producing water is indicated by the water flow shape being significantly smaller than the size of a perforation hole and not at a depth where well records indicate perforation holes exist.

In an embodiment, a casing leak producing water is indicated by the water flow shape being at a depth location where well records indicate perforation holes do not exist. In an embodiment, a casing crack producing water is indicated by the water flow shape being long and thin.

In an embodiment, a leak at a pipe joint junction with another pipe joint is indicated by the water flow depth location being at a junction of two joints as shown on the casing collar log. In an embodiment, a leak at a pipe joint junction with another pipe joint is indicated by the water flow shape being mostly or completely around the circumference of the pipe, and with the depth location being at a junction of two joints as shown on the casing collar log. In an embodiment, water inflow from a water flow shape covering a large massive area indicates a large scale corrosion of the casing.

In an embodiment, the orientation of a water flow relative to the high side of the casing is determined by using auxiliary measurements indicating the orientation of the logging tool during the logging job.

In an embodiment, the depth location of tubing leaks is determined by inserting a plug in the bottom of the tubing, pumping water into the tubing, and generating an array sensor log while pumping water in, to determine the depth location of the outflow of water and thus the depth location of the tubing leak.

In an embodiment, the depth location of produced water is determined by pumping water into a well, and generating an array sensor log over the casing while pumping water in, to determine the depth location of the outflow of water, and thus the depth location of the water production in the well.

In an embodiment, the depth location of a water flow in a central portion of the depth interval of known perforations indicates that the formation is likely producing the water. In an embodiment, the depth location of a water flow in the very top of the depth interval of known perforations indicates that the water is channeling downward from a shallower water bearing zone. In an embodiment, the depth location of a water flow in the very bottom of the depth interval of known perforations indicates that the water is channeling upward from a deeper water bearing zone or that the water is coning upward.

Unless indicated or otherwise obvious from the context, all functions described herein may be performed in either hardware or software, or some combination thereof. In a preferred embodiment, the data analysis functions, for example, are performed by a processor such as a computer or an electronic data processor in accordance with code such as computer program code, software, and/or integrated circuits that are coded to perform such functions, unless otherwise indicated.

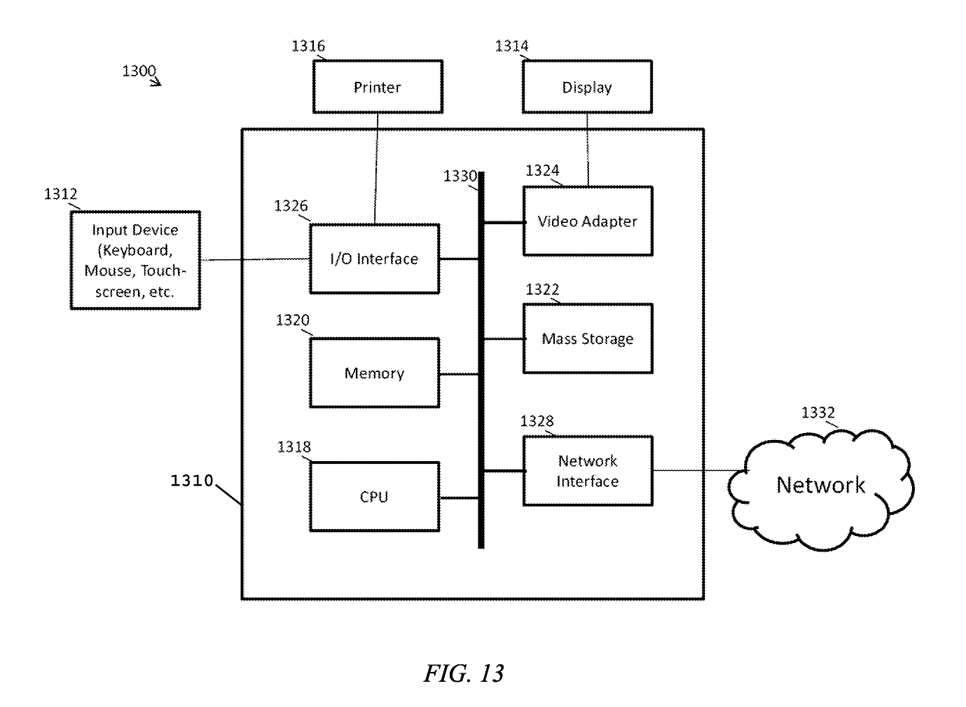

For example, FIG. 13 is a block diagram of a computing system 1300 that may also be used in accordance with an embodiment. It should be noted, however, that the computing system 1300 discussed herein is provided for illustrative purposes only and that other devices may be used. The computing system 1300 may comprise, for example, a desktop computer, a workstation, a laptop computer, a personal digital assistant, a dedicated unit customized for a particular application, or the like. Accordingly, the components of the computing system 1300 disclosed herein are for illustrative purposes only and other embodiments of the present invention may include additional or fewer components.

In an embodiment, the computing system 1300 comprises a processing unit 1310 equipped with one or more input devices 1312 (e.g., a mouse, a keyboard, or the like), and one or more output devices, such as a display 1314, a printer 1316, or the like. Preferably, the processing unit 1310 includes a central processing unit (CPU) 1318, memory 1320, a mass storage device 1322, a video adapter 1324, an I/O interface 1326, and a network interface 1328 connected to a bus 1330. The bus 1330 may be one or more of any type of several bus architectures including a memory bus or memory controller, a peripheral bus, video bus, or the like. The CPU 1318 may comprise any type of electronic data processor. For example, the CPU 1318 may comprise a processor (e.g., single core or multi-core) from Intel Corp. or Advanced Micro Devices, Inc., a Reduced Instruction Set Computer (RISC), an Application-Specific Integrated Circuit (ASIC), or the like. The memory 1320 may comprise any type of system memory such as static random access memory (SRAM), dynamic random access memory (DRAM), synchronous DRAM (SDRAM), read-only memory (ROM), a combination thereof, or the like. In an embodiment, the memory 1320 may include ROM for use at boot-up, and DRAM for data storage for use while executing programs. The memory 1320 may include one of more non-transitory memories.

The mass storage device 1322 may comprise any type of storage device configured to store data, programs, and other information and to make the data, programs, and other information accessible via the bus 1328. In an embodiment, the mass storage device 1322 is configured to store the program to be executed by the CPU 1318. The mass storage device 1322 may comprise, for example, one or more of a hard disk drive, a magnetic disk drive, an optical disk drive, or the like. The mass storage device 1322 may include one or more non-transitory memories.

The video adapter 1324 and the I/O interface 1326 provide interfaces to couple external input and output devices to the processing unit 1310. As illustrated in FIG. 13, examples of input and output devices include the display 1314 coupled to the video adapter 1324 and the mouse/keyboard 1312 and the printer 1316 coupled to the I/O interface 1326.

The network interface 1328, which may be a wired link and/or a wireless link, allows the processing unit 1310 to communicate with remote units via the network 1332. In an embodiment, the processing unit 1310 is coupled to a local-area network or a wide-area network to provide communications to remote devices, such as other processing units, the Internet, remote storage facilities, or the like.

Other devices may be coupled to the processing unit 1310 through I/O interface 1326 or network interface 1328, or otherwise. For example, the microcontroller board of FIG. 3 may be directly or indirectly coupled to processing unit 1310 for analysis of the output data from the microcontroller board. The data may be received and analyzed in real-time while a well is being logged or immediately thereafter, or in a delayed or batch manner any time after a well has been logged. The coupling may include a wired and/or wireless connection, and processing unit 1310 may be located at the site of the well or remote from the well. Alternatively, the circuitry and functions performed by the microcontroller board may be located in or with the processing unit 1310 at a well site, with the analog signal conditioner transmitting the data from the well to the collocated processing unit 1310/microcontroller board.

It should be noted that the computing system 1300 may include other components. For example, the computing system 1300 may include power supplies, cables, a motherboard, removable storage media, cases, a network interface, and the like. These other components, although not shown, are considered part of the computing system 1300. Furthermore, it should be noted that any one of the components of the computing system 1300 may include multiple components. For example, the CPU 1318 may comprise multiple processors, the display 1314 may comprise multiple displays, and/or the like. As another example, the computing system 1300 may include multiple computing systems directly coupled and/or networked.

Additionally, one or more of the components may be remotely located. For example, a display may be remotely located from the processing unit. In this embodiment, display information, e.g., flow rates and other analysis results, may be transmitted via the network interface to a display unit or a remote processing unit having a display coupled thereto.

An embodiment uses an independent set of analog electronics for each measurement flow channel. For example, an embodiment includes 15 flow channels, and 15 sets of analog signal conditioner electronics. The electronics maximize the signal to noise ratio by use of a low initial gain, then a filter to reduce the noise relative to the signal, and then a much higher gain after the filter. The electronics multiplex the results out to an analog to digital converter ADC. A microcontroller controls the operations and timing of the multiplexer and the ADC.

An embodiment generates a flow points map comprising flow rates (or an indication of flow rates) at various measurement sample points around the borehole, which can be thought of as being cut longitudinally and rolled out flat. An embodiment calibrates each flow channel individually, and then applies those calibrations to generate the flow points map.

An embodiment searches for flow groups and finds each flow group by using a threshold applied to each point and seeing if the flow point exceeds the threshold. If so, then it is part of a flow group (contingent upon other conditions). The embodiment searches around that flow point such as by using a user defined distance Rn and searching Rn distance up and down, left and right (a square 2Rn on a side centered on the flow point) for any other flow points exceeding the threshold. If any points are found they are included in the flow group. A square around that point is then searched for flow points. The searching is continued until no more new points are found. That area defines the shape of that flow group.

Other shapes than a square could be used, such as a circle, rectangle, and the like. Each potential flow group may be required to have a minimum number of points in it to be considered a group, as otherwise a large noise spike in one or a few points could erroneously be designated as a group. An embodiment looks for flow groups by the user manually setting the shape of the flow group(s), such as by looking at the data points and then deciding.

An embodiment accounts for multiple measurement sampling by dividing by the appropriate correction factor Cs (number of sample intervals divided into the diameter of the mouth of the flow channel). An embodiment accounts for the geometrical correction to the flow detected and calculated by multiplying by a geometrical correction factor, GF, which for most shapes of flow, such as a geometry of contiguous circles, is GF=4/pi (about 1.2732). Other inflow geometries would have a different geometric correction factor value. If the shape of the inflow is less than the diameter of the inflow mouth, then the value of GF is unity (1.00).

An embodiment calculates the total flow rate within one flow group by summing all the flow rates within that group, dividing by the appropriate multiple sampling factor Cs, and multiplying by the appropriate geometric correction factor GF. An embodiment accounts for sensor swath overlap in generating the flow points map by taking the greatest magnitude values of the overlapping parts on, for example, a point by point basis and using those values to create a non-overlapping flow points map. An embodiment accounts for sensor swath overlap in generating the flow points map by taking the average of two (or more) values from the two overlapping strips. An embodiment accounts for sensor swath overlap in generating the flow points map by using all the points from both rotations and accounting for the higher density of points in the overlapping strip when computing the flow rate.

An embodiment eliminates spurious spikes by checking the number of points within a potential flow group and accepting as a flow group only those flow groups having a (e.g., user set) minimum number of points, and eliminating as a flow group any potential flow group that does not have this minimum number of points. An embodiment eliminates spurious spikes by using a low pass filter.

An embodiment uses the shape of the water inflow to help diagnose the associated anomaly. An embodiment determines a perforation hole producing water by the water flow shape being one or more small roundish holes about the size of a perforation hole and at depths where well records indicate perforation holes exist. An embodiment determines a high flow rate washed out perforation hole producing water by the water flow shape being significantly larger than the size of a perforation hole and at depths where well records indicate perforation holes exist. An embodiment determines a pinhole leak producing water by the water flow shape being significantly smaller than the size of a perforation hole and not at a depth where well records indicate perforation holes exist. An embodiment determines a casing leak producing water by the water flow shape being at a depth location where well records indicate perforation holes do not exist. An embodiment determines a casing crack producing water by the water flow shape being long and thin. An embodiment determines a leak at a pipe joint junction with another pipe joint by the water flow depth location being at a junction of two joints as shown on the casing collar log. An embodiment determines a leak at a pipe joint junction with another pipe joint by the water flow shape being mostly or completely around the circumference of the pipe, and also the depth location being at a junction of two joints as shown on the casing collar log. An embodiment determines large scale corrosion of the casing by the water flow shape covering a large or massive area.

An embodiment determines the orientation of a water flow relative to the high side of the casing by using auxiliary measurements indicating the orientation of the logging tool during the logging operation. An embodiment determines the depth location of tubing leaks by inserting a plug in the bottom of the tubing, pumping water into the tubing, and performs array sensor measurements while pumping water in to determine the depth location of the outflow of water and thus is the depth location of the tubing leak. An embodiment determines the depth location of produced water by pumping water into a well, and performs array sensor measurements over the casing while pumping water in to determine the depth location of the outflow of water, and thus the depth location of the water production in the well.

An embodiment uses the array sensor tool to provide axial depth resolution and circumferential resolution at the scale of the individual flow channels. An embodiment uses the array sensor tool to provide the depth location of water flows relative to perforation locations. An embodiment uses the array sensor tool to provide the depth location of a water flow at a different depth from the depth interval of known perforations to indicate that a casing leak exists at the water flow depth. An embodiment uses the array sensor tool to provide the depth location of a water flow in a central portion of the depth interval of known perforations to indicate that the formation is producing the water. An embodiment uses the array sensor tool to provide the depth location of a water flow in the very top of the depth interval of known perforations to indicate that the water is channeling downward from a shallower water bearing zone. An embodiment uses the array sensor tool to provide the depth location of a water flow in the very bottom of the depth interval of known perforations to indicate that the water is channeling upward from a deeper water bearing zone or that the water is coning upward.

Although the present invention and its advantages have been described in detail, it should be understood that various changes, substitutions and alterations can be made herein without departing from the spirit and scope of the invention as defined by the appended claims. Although the present invention and its advantages have been described in detail, it should be understood that various changes, substitutions and alterations can be made herein without departing from the spirit and scope of the invention as defined by the appended claims. For example, many of the features detailed herein readily can be combined with the applicable features described in previously referenced U.S. patent application Ser. Nos. 12/987,773, 12/947,402, and 12/513,807.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of measuring for radial fluid flow through an interior wall of a casing, the method comprising:
traversing the casing with a sensor pad having a plurality of flow channels, wherein each flow channel comprises a pair of electrodes, and wherein an imaginary line between the two electrodes in the pair of electrodes is substantially orthogonal to the flow channel;
positioning the sensor pad adjacent to the interior wall of the casing, such that flow axes of the plurality of flow channels are oriented radially in the casing and substantially perpendicular to the casing wall;
generating a magnetic field substantially orthogonal to the flow channels and substantially orthogonal to the imaginary line between the two electrodes in each flow channel;
generating, by each pair of electrodes, an induced voltage indicative of a substantially radial flow of conductive fluid entering or leaving the interior wall of the casing; and
sensing the induced voltage using an independent analog signal conditioner circuit for each of the flow channels.

2. The method of claim 1, wherein there are fifteen flow channels and fifteen respective analog signal conditioner circuits.

3. The method of claim 1, further comprising each analog signal conditioner circuit low gain amplifying the respective sensed voltage to generate a low gain signal.

4. The method of claim 3, further comprising each analog signal conditioner circuit low pass filtering the respective low gain signal to generate a low pass filtered signal.

5. The method of claim 4, further comprising each analog signal conditioner circuit high gain amplifying the respective low pass filtered signal to generate a high gain signal.

6. The method of claim 5, further comprising multiplexing the high gain signal from each analog conditioner circuit to generate a time-multiplexed analog signal.

7. The method of claim 6, further comprising converting the time-multiplexed analog signal to a serial digital signal comprising data for each flow channel.

8. The method of claim 7, further comprising a microcontroller generating control signals to control operation and timing of the multiplexing and the converting.

9. The method of claim 7, further comprising amplifying the time-multiplexed analog signal prior to the converting.

10. The method of claim 7, further comprising individually calibrating the data for each flow channel.

11. An array sensor tool comprising:
a sensor housing having a sensor face and a sensor back;
a plurality of flow channels spaced along a length of the sensor housing, wherein each flow channel has a first opening in the sensor face and a second opening in the sensor back;
a magnetic field source, oriented to generate a magnetic field substantially orthogonal to the flow channels;
a plurality of electrode pairs, wherein each electrode pair is disposed in a respective one of the plurality of flow channels, and wherein, for each electrode pair, an imaginary line between the two electrodes in the electrode pair is substantially orthogonal to the respective flow channel and to the magnetic field; and
a plurality of independent analog signal conditioner circuits, wherein each analog signal conditioner circuit has an input coupled to a respective one of the electrode pairs.

12. The array sensor tool of claim 11, wherein there are fifteen flow channels and fifteen respective analog signal conditioner circuits.

13. The array sensor tool of claim 11, wherein each analog signal conditioner circuit comprises a low gain differential amplifier having inputs coupled to the respective electrode pair.

14. The array sensor tool of claim 13, wherein each analog signal conditioner circuit further comprises a low pass filter having an input coupled to an output of the differential amplifier.

15. The array sensor tool of claim 14, wherein each analog signal conditioner circuit further comprises a high gain amplifier having an input coupled to an output of the low pass filter.

16. The array sensor tool of claim 15, further comprising a multiplexer having a plurality of inputs, wherein each input is coupled to an output of a respective high gain amplifier.

17. The array sensor tool of claim 16, further comprising an analog-to-digital converter (ADC) having an input coupled to an output of the multiplexer.

18. The array sensor tool of claim 17, wherein the ADC comprises a digital serial data output.

19. The array sensor tool of claim 17, further comprising a microcontroller having a control line coupled to the multiplexer and a control bus coupled to the ADC.

20. The array sensor tool of claim 17, further comprising an amplifier coupled between the multiplexer and the ADC.
